(19) United States
(12) Patent Application Publication
(10) Pub. No.: US 2020/0370183 A1
(43) Pub. Date: Nov. 26, 2020

(54) PROTECTIVE SURFACE TREATMENT FOR METAL ALLOY COMPONENTS DURING MANUFACTURING AND THEREAFTER

(71) Applicant: MAGNA INTERNATIONAL INC., Aurora (CA)

(72) Inventors: Roland David SEALS, Oak Ridge, TN (US); Kenneth Ray ADAMS, Oakland Township, MI (US); Di YANG, Troy, MI (US); Jeremiah John BRADY, Knoxville, TN (US); Edward Karl STEINEBACH, Oak Ridge, TN (US); Vinod Kumar SIKKA, Oak Ridge, TN (US)

(21) Appl. No.: 16/636,222

(22) PCT Filed: Aug. 9, 2018
(86) PCT No.: PCT/US2018/045951

§ 371 Date: Feb. 3, 2020

Related U.S. Application Data
(60) Provisional application No. 62/543,675, filed on Aug. 10, 2017.

(51) Int. Cl. C23D 5/02; F16H 55/06; B62D 29/00; C03C 8/16; C03C 8/02; C09D 139/06; C09D 131/04; C09D 133/00; C09D 7/20; C09D 7/61

(52) U.S. Cl. CPC C23D 5/02; F16H 55/06; B62D 29/007; C03C 8/16; C03C 8/02; B62D 25/04; C09D 131/04; C09D 133/00; C09D 7/20; C09D 7/61; C09D 139/06

(57) ABSTRACT

A protective surface treatment in the form of a coating for steel or another metal or metal alloy capable of providing oxidation resistance in an inert gas furnace or air-containing furnace is provided. The coating is formed by a solution including at least one flux agent, such as boric acid, and at least one binder, such as polyvinylpyrrolidone (PVP), polyvinylpyrrolidone/vinyl acetate (PVP/VA), hydrooxypropylcellulose (HPC), ethylcellulose, and/or acrylics. The solution also includes at least one solvent, such as methanol or ethanol and can include various additives. The finished coating includes iron borate and provides a glassy surface.

### CROSS REFERENCE TO RELATED APPLICATION

This PCT International Patent Application claims the benefit of U.S. Provisional Patent Application Ser. No. 62/543,675 filed Aug. 10, 2017 entitled “Protective Surface Treatment For Metal Alloy Components During Manufacturing And Thereafter,” the entire disclosure of the application being considered part of the disclosure of this application and hereby incorporated by reference.

### BACKGROUND OF THE INVENTION

### 1. Field of the Invention

The invention relates generally to a surface treatment for metal components, more specifically a method of manufacturing a metal component using a surface treatment, a metal component manufactured using a surface treatment.

### 2. Related Art

Metal components for vehicles, such as those formed of steel or another metal or metal alloy, are oftentimes hot formed to achieve a desired shape, strength, ductility, and other physical properties. However, heating of the metals during the hot forming process, especially steel in air, to temperatures in the range of 600 to 1200° C. can cause excessive surface oxidation. Under austenization conditions, an oxide scale formation and decarburization typically occurs immediately when the steel is in contact with air at an austenization temperature.

Several issues can arise due to the surface oxidation of the steel or other metal. For example, an oxide scale changes the dimensions of the component by the extent of the resistance of the metal to air oxidation. Some scales can be as thick as 1 to 2 mm. Oxide scale can also cause loss of the metallic material and build-up in a furnace used for heating the parts. The oxide scale can also cause excessive die wear during the forming operation. If the oxide scale builds up in the forming die, the build-up can cause surface defects on the hot formed component. For steels, air oxidation can cause excessive surface decarburization. Furthermore, components formed after heating in air require typically oxide scale removal. Scale removal methods include sand or grit blasting, chemical cleaning, and others, all of which add costs to the manufacturing process and manufactured component. The costs are in the form of material loss, labor, cost of products used for removing the scale, disposal of the scale removed, and extra manufacturing spaces for such operations.

Thus, it has been an objective of manufacturers, including those who hot stamp and process uncoated boron steel, to make iron and steel articles capable of withstanding comparatively high temperatures without scaling. For hot stamping uncoated steel, the scaling issue has not been completely solved.

Several approaches have been used to counter the issues listed above that can arise due to heating of the metal in air for forming operations. One technique used to counter the oxidation problem includes surface coating of the steel or metal component. For example, different coating types and purposes of using them are possible, each with advantages and disadvantages, which are listed in the following table. The table refers to hot dipped aluminized steel (Al/Si-layer) as being weldable, but due to the formation of the iron aluminide phases at the interface, the weldability is very difficult.

| Coating Type | Usage/Advantage/Disadvantage |
|---|---|
| Hot dipped | Only for direct process (cracks if cold) |
| Aluminized steel | Weldable without sand blasting |
| (Al/Si-layer) | Hard surface and abrasive |
| | Moderate corrosion protection |
| Hot dipped | Cathodic corrosion protection |
| galvanized steel | Direct or indirect stamping process |
| (Zn-layer) | Diffusion of Zn into steel matrix |
| | Evaporation of & contamination with Zn |
| | Not weldable; sand blasting required |
| Hot dipped | Cathodic corrosion protection |
| Zn-/Ni-layer (90/10) | Safety issues with Ni |
| Silane/Al-based | Not weldable; sand blasting required |
| Inorganic coating | No corrosion protection |

A first example is a dip coating of aluminum-silicon (Al—Si) on the steel or metal component. The coating is applied by dipping the steel through a molten bath Al—Si at a temperature of >660° C. and up to 750° C., and the temperature must be above melting point of Al—Si. Such a coating tends to provide good oxidation resistance to steel when it is heated in air at temperatures of 940 to 950° C. However, the dip coating technique has limitations. Such a coating adds significant cost to the bare steel or metal cost, and the process controls are good but still highly non-reproducible. The Al—Si coating results in a thin protective surface coating, but because of coating thickness variability, the final color of the finished component gives a variety of colors indicative of lack of process control. Such a variability in final component color increases the rejection rates and adds to cost. Finally, since the coating of Al—Si create intermetallic phase with iron, which is commonly more brittle than the steel or metal, the coated steel or metal tends to be more susceptible to surface crack initiation at the intermetallic phase sites.

Another example technique includes application of inorganic protective coatings. There are several key features associated with the process. An inorganic binder system is necessary, such as a siloxane binder system for the coating and pretreatment based on silicate/silane chemistry. In addition, aluminum (Al) flakes are used to build up an oxygen barrier, and pigmentation is used for better corrosion performance and spot welding. For example, heat resistant conductive pigments which have good electrical and thermal conductivity, low melting point, high boiling point, and moderate hardness can be used in combination with Al-flakes. The main issue with the inorganic protective coating is that it uses inorganic binders, which are typically water based, and thus, the coated surface is susceptible to rusting while waiting to be heated.

In addition to the coatings, several other key technologies and techniques can be used to prevent air oxidation, and each has key features and disadvantages. For example, a protecting or inert atmosphere can be used in the furnace during the heating step. The use of costly controlled atmosphere furnaces are typically needed. The atmosphere can be a nitrogen gas, hydrogen gas, and/or mixture of gases. This method can be used in commercial production, but it has limitations. For example, use of the protecting or inert atmosphere requires expensive gas delivery systems on the furnaces. Other limitations include costs of gases used and safety requirements while using the gases.

Furthermore, although inert gas use reduces the surface oxidation, the parts processed in such furnaces still require some post processing of sand and/or grit blasting and some chemical cleaning. To reduce surface oxidation and decarburization after hot stamping, the surfaces of the metal need the cleaning, for example using a sandblaster. The sandblasting process is not just high cost, but also has side effects. For example, some shadow locations on the surface cannot get completely clean; and the parts can twist or experience distortion due to high energy input by high speed sandblasting.

### SUMMARY

A surface treatment for steel or another metal or metal alloy providing a protective surface during manufacturing and thereafter is provided. The surface treatment is capable of providing oxidation resistance in a furnace, such as a furnace containing air or an inert gas.

One aspect of the invention provides a method of manufacturing a component with the surface treatment. The method comprises the steps of applying a mixture to a body portion, and heating the mixture on the body portion to a temperature in the range of 200 to 1200° C. The body portion includes a metal or metal alloy. The mixture includes a flux agent, at least one binder, and at least one solvent. The flux agent includes at least one of boric acid; sodium borate; sodium tetraborate; disodium tetraborate; boron oxide; calcium fluoride; sodium carbonate; potash; charcoal; coke; lime; lead sulfide; ammonium chloride; limestone; metal halide; zinc chloride; hydrochloric acid; phosphoric acid; hydrobromic acid; salt of a mineral acid; mineral acid with amine; carboxylic acid; fatty acid; amino acid; organohalide; boron; and silicon; a mixture containing 20 wt. % MnO, 15 wt. % CaF₂, and SiO₂ to CaO ratios varying from 5.50 to 1.16; tin(II) chloride; a fluoride; and precursors to silicate and borosilicate glasses.

Another aspect of the invention provides a component manufactured with the surface treatment. The component comprises a body portion including a metal or metal alloy, and coating disposed on the body portion. The coating includes iron borate.

### BRIEF DESCRIPTION OF THE DRAWINGS

FIGS. 1A and 1B each include a schematic for the overall surface treatment process according to example embodiments of the invention;

FIG. 2 is a graph with data, including relative hygroscopicity, of binders that can be used in the surface treatment process according to example embodiments;

FIG. 3 illustrates absorption or reaction of boric acid and an oxidized iron-containing surface;

FIG. 4 is a phase diagram of a binary system Fe₂O₃—B₂O₃;

FIG. 5A illustrates a coated component according to an example embodiment of the invention;

FIG. 5B is a cross-sectional view of a portion of the coated component of FIG. 5A;

FIG. 6 is a plot showing a glass forming treatment thickness versus weight for the composition of example 9;

FIG. 7 illustrates weight change from heating the glass treatment treated steel when heated for 5 minutes at 940° C. in air and nitrogen atmospheres as a function of glass forming treatment weight in g/m\hat{ }2;

FIG. 8 illustrates weight change from heating the glass treatment treated steel when heated for 5 minutes at 940° C. in air and nitrogen atmospheres as a function of glass forming treatment thickness in microns;

FIG. 9 illustrates decarburization depth in steel from heating the glass treatment treated steel when heated for 5 minutes at 940° C. in Nitrogen atmospheres as a function of glass forming treatment weight in g/m\hat{ }2;

FIG. 10 illustrates weight change from glass forming from heating the glass treatment treated steel samples when heated for 5 minutes at 940° C. in Nitrogen atmospheres as a function of glass forming treatment weight in g/m\hat{ }2, and the data is for spray and roll application methods; and

FIG. 11 illustrates weight change from glass forming from heating the glass treatment treated steel samples when heated for 5 minutes at 940° C. in Nitrogen atmospheres as a function of glass forming treatment weight in g/m\hat{ }2, and the data is for spray, paint, and roll application methods.

### DETAILED DESCRIPTION OF EXAMPLE EMBODIMENTS

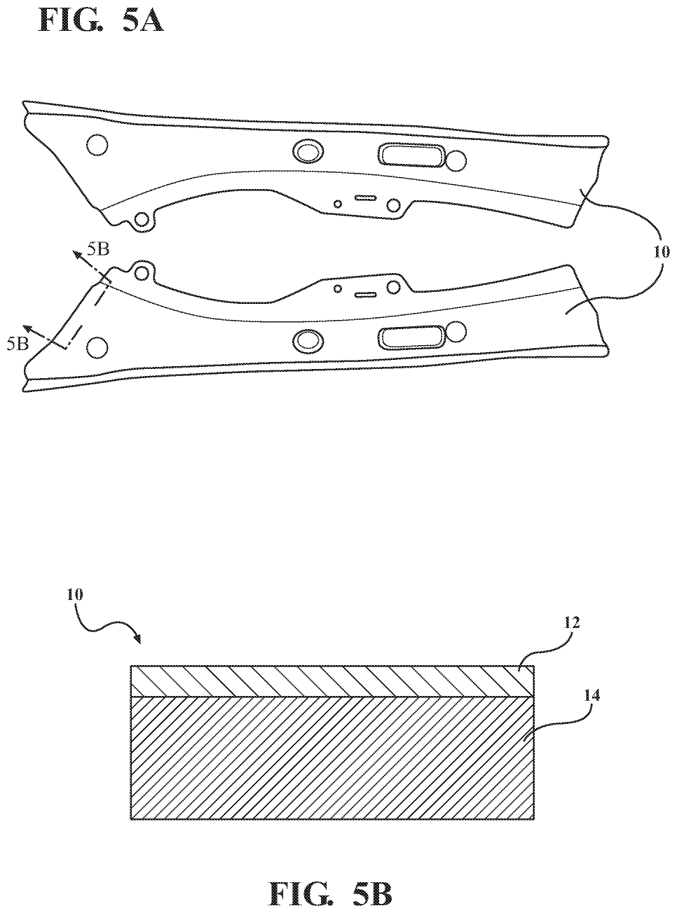

A surface treatment for steel or another metal or metal alloy component capable of providing oxidation resistance in air or during hot forming of the component in a furnace, such as a furnace with an atmosphere of air or inert gas, is provided. The component 10 can be in the shape of a pillar designed for use in a vehicle, as shown in FIG. 5, but other designs are possible. The coating 12 is disposed on a body portion 14 of the component, and the coating is formed from a mixture which includes at least one flux agent, at least one binder, at least one solvent, and optional additives.

The body portion is formed of the metal or metal alloy, such as steel. For example, the steel can be plain carbon steel or high strength steel.

The mixture can be used in a surface treatment process for metal alloy components. The surface treatment process was designed to provide a protective surface during manufacturing and thereafter, with the same or better mechanical properties, same or better forming response, same or better weldability, oxidation and corrosion resistance, and lower cost, compared to existing processes. The objective was also to develop surface treatments for steels, metals, and metal alloys that provide the oxidation resistance in inert gas furnaces and in air furnaces and yet address all of the issues discussed above associated with the currently used treatments and coating processes. More specifically, the focus was to develop a solvent-based treatment that contains at least one fluxing agent and binder that attaches the flux agent(s) to the steel or metal surface. The at least one solvent evaporates during air drying or at a low temperature cure treatment, such as less than 150° C., and the binder typically burns off during heating at high temperatures of 900 to 975° C. This leaves the flux to react with an iron oxide layer on the body portion of the component, which is only a few atoms thick on the steel or metal surface, to form a highly protective complex oxide layer. The complex oxide layer falls into the category of a glass structure. Results of the solvent based treatment have proven very successful for heating bare steel in a nitrogen atmosphere and air furnaces.

The improved surface treatment process developed preferably includes applying a mixture (also referred to as a solution), for example a clear solution of an active chemical, such as boric acid, in a solvent and a binder with other additives, to the body portion of the component, which is typically formed of a material including iron, such as steel or another metal, at room temperature. Several application methods can be used to apply the mixture. When heated to temperatures ranging from 500 to 1000° C. under a variety of heating atmospheres, the mixture protects the steel or metal from air oxidation.

### Active Chemical/Flux Agent

The active chemical can include any precursors or chemicals that can form or react to form flux agents, such as boric acid. As an example, compounds of boron and borax can be used to produce boric acid (H₃BO₃), as:

Na₂B₄O₇+H2O→{2Na++B₂O₇²⁻}→2OH−+4H₃BO₃

BN or B₂S₃ or BCl₃+H₂O→H₃BO₃

Borax can also be used to produce boric acid (H₃BO₃), as:

Na₂B₄O₇.10H₂O+2HCl→4H₃BO₃+2NaCl+5H₂O

Any reactions that result in the formation of B₂O₃ which reacts with surface rust (and/or oxides of metals) to form iron borate (and/or metal borates) are also possible, such as:

Na₂B₄O₇+heat→B₂O₃

Typically, the flux agent is boric acid or sodium borate, although other flux agents are possible. The boric acid can be granular or powdered. The boric acid, in an amount of 1-20% by weight, based on the total weight of the solution, can also be dissolved in the solvents described below. According to an example embodiment, the weight % of the boric acid in the solution varies from 5-20% of the total weight of the solution. Borax, sodium borate, sodium tetraborate, boron oxide (B₂O₃), or disodium tetraborate are also possible flux agents.

The maximum amount of boric acid can be up to the solubility limit of boric acid in the solvent (carrier agent). Thus, as examples, the maximum solubility of boric acid in methanol is about 20% by weight and the maximum solubility of boric acid in ethanol is about 10% by weight. The amounts refer to all of the boric acid dissolved in the solvent.

Another aspect of this invention is that the active agent can be added beyond the solubility limit of active agent (example: boric acid) in the solvent or carrier agent as suspended particles. Thus, in addition to the amount of boric acid in solution (dissolved), additionally boric acid can be added as suspended particles in the solvent. Accordingly, as an example embodiment, the weight % of the boric acid can be as suspended particles varying up to the remainder of the total weight of the mixture; however, more preferably as 1-22% of the total weight of the mixture. As another embodiment, an example of 22% of the total weight in ethanol, the boric acid is in the form as 10% dissolved (in solution) and 12% suspended particles of the total weight of the mixture.

A mixture herein refers to a liquid with materials suspended in a solvent or to a liquid with materials as dissolved and suspended in the solvent, whereas a solution refers to materials dissolved in a solvent.

The sodium borate can vary from 0-10% by weight, based on the total weight of the solution, in conjunction with boric acid. The sodium borate may also be used alone in the range of 3-10% by weight, based on the total weight of the solution. Since the reaction of one molecule of anhydrous borax produces 4 molecules of boric acid, the amount of anhydrous borax should be 0.814 times the amount of boric acid that is typically used in solution.

Other flux agents can be used in the solution. For example, the flux agent can include at least one of boric acid; sodium borate; sodium tetraborate; disodium tetraborate; boron oxide; calcium fluoride; sodium carbonate; potash; charcoal; coke; lime; lead sulfide; ammonium chloride; limestone; metal halide; zinc chloride; hydrochloric acid; phosphoric acid; hydrobromic acid; salt of a mineral acid; mineral acid with amine; carboxylic acid; fatty acid; amino acid; organohalide; boron; silicon; a mixture containing 20 wt. % MnO, 15 wt. % CaF₂, and SiO₂ to CaO ratios varying from 5.50 to 1.16; tin(II) chloride; a fluoride; and precursors to silicate and borosilicate glasses.

The flux agent is typically present in an amount of 1 to 30% by weight, based on the total weight of the solution or mixture.

### Binder

The binder content can vary from 1 to 60% by weight of the solution, typically 1 to 30% by weight of the solution. When the boric acid is used as the flux agent, the binder for the boric acid solution is preferably chosen so that it has a melting point nearly same as that of boric acid of 339° F. For example, the binder can be one or more of polyvinylpyrrolidone (PVP), polyvinylpyrrolidone/vinyl acetate (PVP/VA), hydroxypropyl cellulose (HPC), ethylcellulose, acrylic copolymers and acrylate (such as methacrylate copolymer, ethyl methacrylate, isobutyl methacrylate, tert-butyl methacrylate, and the mixture of acrylic acid, methyl methacrylate, ethyl acrylate, and ethyl acetate) which are preferred when the flux agent is boric acid.

Acrylates or acrylic copolymers can also be used as a binder. There are many acrylates and acrylic copolymers which are suitable such as butyl acrylate. Acrylics are polyesters based on acrylic acid formed from the polymerization of an alkyl acrylate ester. First, the monomer is formed from the reaction between acrylic acid and an alcohol as follows:

acrylic acid+alcohol→alkyl acrylate

Second, a radical (i.e. a molecule with an odd number of electrons) then adds to one end of the double bond of the alkyl acrylate forming a radical monomer which then polymerizes.

Acrylates and acrylate copolymers are available as resins from several commercial sources including American Color, Inc., Dianal America, Inc., Lucite International, and Dow Corning Corporation. The resins are typically thermoplastics; are thermally stable up to 177-232° C. (350-450° F.); and undergo depolymerization to monomers, leaving negligible ash, at about 260° C. (500° F.). Examples of acrylate resins that work well as binders in the preparation of the protective surface treatment mixture are methacrylate copolymer such as Elvacite 2028, ethyl methacrylate such as Elvacite 2043 or Dianal BR-220, isobutyl methacrylate such as Elvacite 2045, butyl methacrylate such as Dianal BR-115, acrylate resin TB-0044 from Dianal, and tert-butyl methacrylate. Another binder example is the mixture of acrylic acid, methyl methacrylate, ethyl acrylate, and ethyl acetate. In this latter case, the mixture contains acrylic acid (5 to 60% by weight), methyl methacrylate (5 to 60% by weight), ethyl acrylate (5 to 60% by weight), and ethyl acetate (1 to 10% by weight). A preferred mixture is 15% acrylic acid, 40% methyl methacrylate, 40% ethyl acrylate, and 5% ethyl acetate.

The T_{g} values for Elvacite 2028, Elvacite 2043, Elvacite 2045 are 45, 65, and 55, respectively. The molecular weights for Elvacite 2028, Elvacite 2043, Elvacite 2045 are 59,000, 50,000, and 193,000, respectively.

An example of a binder system is any acrylate, acrylic acid, and acrylic copolymer or any acrylate and acrylic acid that forms an acrylic copolymer, whereby the acrylate or acrylic acid or acrylic copolymer is soluble in any solvent that can dissolve or suspend a flux agent such as boric acid, borax, or any boric acid or boron oxide forming chemicals.

Acrylate polymers belong to a group of polymers which could be referred to generally as plastics. They are noted for their transparency, resistance to breakage, and elasticity. They are also commonly known as acrylics or polyacrylates. When acrylate is used as a binder, the deposited surface treatment system is moisture resistance after curing and subsequently.

The PVP polymer can be of any molecular weight ranging from 4000-6000 g/mol to 2,100,000-3,000,000 g/mol. The PVP is typically in the form of granular powder, and the PVP is typically dissolved in any of the solvents described below in the range of 10 to 60% by weight, based on the total weight of the solution. According to one embodiment, 100% of the binder is PVP. Alternatively, PVP can be used in combination with other binders, where the other binders may be 10 to 90% of the total binder weight. The PVA/VA polymer binders are viscous liquids. The PVP/VA can have a PVA/VA ratio of 30/70 to 70/30. For example, the PVP/VA can be the type referred to as S630 and/or E335. The VA content in the PVA/VA increases its resistance to moisture under high humidity conditions. Thus, the PVA/VA ratio of 30/70 has the highest resistance. The HPC binder is soluble in many of the organic solvents described below, including methanol, ethanol, and isopropyl alcohol. The type of HPC used can be the type sold under the name Klucel™. An example of a more specific HPC with most resistance to moisture pickup is HPC-E. An example of the ethylcellulose is N200, which is most resistant to moisture pick-up.

Typically, the process includes an initial heating step to cure the binder. The initial heating step can be conducted in a furnace at a temperature in the range of 100 to 300° F.

### Solvent

The mixture includes at least one solvent, and can include two or more solvents. The solvent for the surface treatment can be methanol, ethanol, denatured alcohol, or mixtures thereof. For example, the mixtures can include two or three solvents. The at least one solvent forms the balance of the 100% of the solution. The solvent can include 100% by weight, based on the total weight of the solvent, of one or more of the previously listed solvents, or can contain 0 to 99% of other solvents in any combinations. A preferred solvents used when the flux agent is boric acid are methanol and ethanol.

Any solvent which will either dissolve or suspend the flux or active agent, such as boric acid or boric acid forming agent (such as borax), can be used as an effective carrier. Preferred solvents used when the flux agent is boric acid are methanol and ethanol; however, ethanol is more environmentally friendly.

### Additives

Various additives can be added to the solution or mixture (suspension) of the protective surface treatment, typically in an amount varying from 0.1 to 10% of the total weight of the solution or mixture.

Typically, the additives include at least one surfactant in an amount varying from 0.1 to 1% by weight of the solution. Other ingredients that may be incorporated in the solutions include solvent soluble elements or compounds of Zn, Cr, Mn, Si, B, Al, Cu, Co, Ni, Zr, Hf, Ti, Ta, Mo, W, Ag, Au, Fe, TiO₂, SiO₂, Al₂O₃, and/or SiO₂—Al₂O₃. Solutions of the various elements or compounds previously described may be added individually or in combination as two or more. The solution additions are typically chosen to impart surface and near surface elemental enrichments of 0.001 to 1.00%. Certain elements, such as nano sized particles of C, B. Si, Al, Zn, and others may also be incorporated in the solutions. The nano sized particle additions may vary from 0.001 to 10% by weight, based on the total weight of the solution. Nano sized particles of certain oxides may also be included in the solutions. For example, the nano sized oxides may be oxides of Al, Si, Ti, Cr, Mo and others.

Viscosity enhancement chemicals, anti-settling chemicals, and lubricant chemicals can also be used as additives. Chemicals or liquid rheology additives used to enhance viscosity, such as BYK 410, BYK 420, and other BYK products, are stirred into the protective surface treatment typically to generate a three-dimensional network structure. The resulting thixotropic flow behavior prevents sedimentation and increases the anti-sagging properties without impairing leveling. The recommended levels are 0.2-1% additive (as supplied) based upon the total formulation to prevent settling and 0.5-2% to prevent sagging.

An example of a lubricant is steric acid added to the solution or mixture at a 0.5-10% level; however, the surface treatment chemical components are inherently lubricious during the forming process.

Eastman™ PM Acetate (Propylene Glycol Monomethyl Ether Acetate) is an additive used to slow the evaporation of the solvent. PM Acetate is used with the binders including acrylic or acrylic copolymers, cellulose acetate butyrate, nitrocellulose, epoxy resins, and phenoxy resins. The combination of slow evaporation rate and good solvent activity makes PM acetate an effective retarder solvent.

### Coating Process

According to the example embodiment, the boric acid solution is prepared by mixing solutions of boric acid and one or more of the binders listed above. The solutions may contain boric acid from 2-30% and binders from 2-20% by weight, based on the total weight of the solution. For example, a preferred solution contains 10% boric acid and 3-4% binder in methanol. Other preferred solutions contain 15-20% boric acid and 4-8% of binder in methanol. Another preferred solution may contain 10% boric acid, 3-14% acrylic binder in ethanol. However, other flux agents, binders, solvents, and additives can be used instead of those listed above.

Other preferred solutions contain 15-20% boric acid and 3-14% of binder in methanol. The boric acid can also be added as a suspension beyond the solubility limit. For example, a preferred suspension or mixture contains 11-22% boric acid and 3-14% binder in either ethanol.

The following is shown as an example of a method of making a protective surface treatment mixture:

Step 1: Add acrylate copolymer binder, 12% by weight, to ethanol carrier

Step 2: Add boric acid, 17% by weight, to ethanol carrier/acrylate binder system (note: ˜10% boric acid dissolves & ˜7% suspended)

Step 3: Add an additive, such as BYK420 or a surfactant, <1-5% by weight, to carrier/binder/active agent

The additive can be added after any step but is typically added after step 1.

The solution can be applied on the steel and metal surfaces by a variety of methods including spraying, painting using brushes, and rolling using rollers. For example, the solution can be applied continuously on coils of the steel or other metal at high speed using inline roller application methods. For example, the roll application speeds can range from 100 to 500 ft./min. Prior to application of the solution, the steel and metallic surfaces can be made oil free by either solvent cleaning or chemical cleaning. Solvents used for cleaning of the steel and metallic surfaces can be acetone, MEK, or mixtures of thereof. The chemical cleaning of steel can be carried out by alkali based solutions, for example solutions consisting of 1-2 weight % of KOH or NaOH, based on the total weight of the cleaning solution. These processes can be used in line for coil coatings. The amount of the mixture on the steel or metal after applying the solution ranges from 1.0 to 20 g/m².

After the mixture is applied to the body portion formed of steel or another metal or alloy, the process includes heating the mixture to cure the binder, and heating the mixture, typically in a furnace, to forming the glass coating. Preferably, the furnace temperature is in the range of 200 to 1200° C., and the furnace atmosphere is air or inert gas such as nitrogen. Alternatively, the atmosphere could be a mixture of nitrogen and natural gas.

When the mixtures on the steel surface are processed in a continuous furnace in a nitrogen atmosphere at 940° C. for 5 minutes, the mixtures produce iron borate on the steel surface. The mixtures also produce iron borate on the steel surface when processed in a continuous furnace in air atmosphere at 940° C. for 5 minutes. The color of the iron borate surface can vary from blue to gray, depending on relative contents of iron oxide and boron oxide in the mixture. When processed in nitrogen, 10% boric acid typically produces the gray color surface on the metal part that requires nearly 15-20% boric acid for processing in air. The iron borate can also appear as an orange or yellowish-orange color on the surface, but preferably the surface treatment results in a gray or bluish-gray surface.

The iron borate surface coating produces a uniform surface on hot formed and quenched parts whether processed by heating at 940° C. for 5 minutes in air or nitrogen atmosphere. The hot formed and quenched parts which include the iron borate surface coating providing the uniform surface after processing by heating at 940° C. for 5 minutes in air or nitrogen atmosphere can also be E-coated using a regular E-coating process. The iron borate surface coating providing the uniform surface on the hot formed and quenched parts whether processed by heating at 940° C. for 5 minutes in an air or nitrogen atmosphere also results in an ultrafine microstructure with potential benefits of improved mechanical properties and a minimum decarburization layer in steel.

In summary, the solution of boric acid in a solvent and binder with additives can produce novel surfaces on steel and other metals. The solution also produces steels with improved properties as opposed to uncoated steel. The iron borate coated surface is also highly resistant to general corrosion and can be selectively dissolved in a 5% HCl solution.

### Additional Details and Examples

Additional details and examples of the protective surface treatment process and related materials for application to steel, metal, and metal alloy components to provide a protective surface during manufacturing and thereafter will now be described. More specifically, various chemicals and/or slurries including flux agents, binders, suspending agents, dispersants, solvents, surfactants, metal coating compositions, along with pre-coating surface treatments, application processes, and the usage will be described. There are several key aspects to the composition and application of the protective surface treatment to the metal alloy components, such as steel substrates or other metal components, to provide a protective surface for use during manufacturing and thereafter. The chemical agents used in the process treatment act as chemical cleaning agents, flowing agents, and/or purifying agents. The chemical composition typically has more than one function at a time. The surface treatment agents serve various functions, the simplest being as a reducing agent which prevents oxides from forming on the surface of the component; typically in a surface heated soften state or a molten state. The surface applications of the chemical treatment substances, which are nearly inert at room temperature, typically become strongly reducing at elevated temperatures, prevent the formation of metal oxides. The surface applications of the chemical treatment substances typically dissolve oxides on the metal surface, which facilitates wetting by the near surface softened or molten metal, and act as an oxygen barrier by coating the hot surface, preventing its oxidation. Additionally, the ingredients of the chemical treatment substances allow coatings to flow easily on the component rather than forming beads as it would otherwise. Additional functions involve the absorption of impurities into the surface treatment region which can be removed or scraped off the metal component surface.

As discussed above, the chemical components of the surface treatment include one or more flux agents, at least one binder or vehicle agent, at least one solvent chemical or carrier, and additives. At a minimum, at least one flux agent must be present to disrupt, dissolve, prevent, or react with surface oxides. The binder or vehicle agents are typically high-temperature tolerant chemicals in the form of non-volatile liquids or solids with a suitable melting point. The binders are generally softened or molten at component processing temperatures and act as an oxygen barrier to protect the hot metal surface against oxidation, to dissolve the reaction products of flux agents and oxides and carry them away from the metal surface, and to facilitate heat transfer. The binder or vehicle agents typically form networks similar to polymeric structures. Binders are vaporized leaving the flux agent as the active agent to form the protective surface. As an example, an acrylate binder will vaporize in a nitrogen atmosphere at ˜400° C. with >99% being vaporized by 425° C. In some cases, the active agent and the binder are one and the same chemical component. The carrier agents are chemicals or solvents used to disperse the flux agents. Typically, the carrier is removed during the component manufacturing process, and normally by evaporation. The additives are chemical agents that act as wetting agents, surfactants, viscosity enhancers, anti-settling agents, leveling agents, corrosion inhibitors, stabilizers, tackifiers, plasticizers, dyes, and/or decarburization prevention agents.

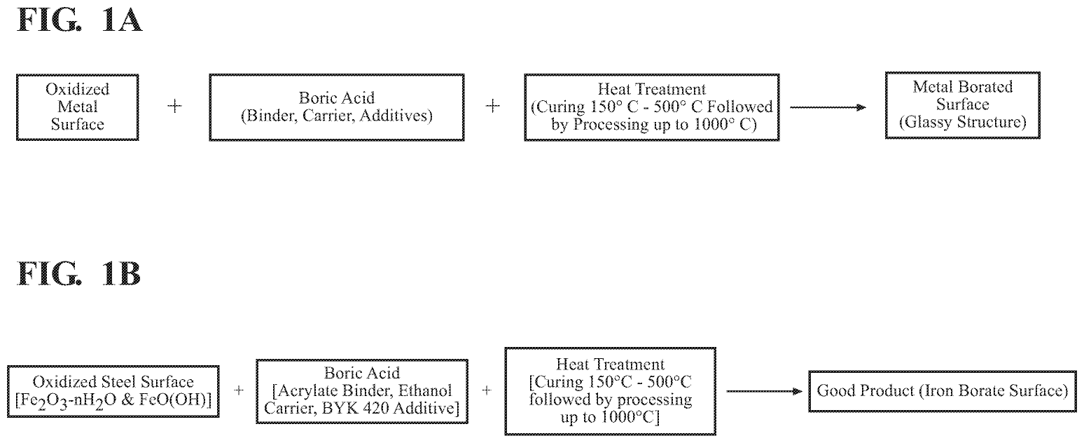

The overall protective surface treatment process can be represented by the equation given in FIG. 1. As an example, on a steel surface, the protective surface treatment process can be represented as follows: Steel Surface (FeₓO_{y})+Boric Acid (PVP/PA, Methanol, Carbowax)+Heat (Cure at 400° C.; process at 940° C.)→Good Product (Iron Borate Glass). The steel surface is typically composed of molecular levels of iron oxide, iron oxyhydroxide, and/or iron rust, [Fe₂O₃.nH₂O and FeO(OH)], which also reacts with the boric acid to from iron borate. The main components of the surface treatment process will be described further below. The main components of the overall protective surface treatment are shown in FIGS. 1A and 1B.

Boric acid is an example of the flux agent, but other flux agents could be used. The possible flux agents include sodium carbonate, potash, charcoal, coke, borax (sodium borate, sodium tetraborate, or disodium tetraborate), boric acid, boron oxide, lime, lead sulfide, ammonium chloride, limestone, metal halides (such as calcium fluoride and zinc chloride), hydrochloric acid, phosphoric acid, hydrobromic acid, salts of mineral acids (hydrochloric, nitric, phosphoric, sulfuric, boric, hydrofluoric, hydrobromic, perchloric, hydroiodic), mineral acids with amines (RNH2, RR′NH, RR′R″N), carboxylic acids (RCOOH; COOH—R—COOH, i.e., dicarboxylic acids); fatty acids i.e., oleic acid and stearic acid, amino acids, organohalides. Self-fluxing alloys usually contain temperature suppressants such as boron and/or silicon. Silicon in conjunction with boron has self-fluxing characteristics.

Flux serves various functions, the simplest being a reducing agent which prevents oxides from forming on the surface of the heated metal or molten metal, while others absorbed impurities into the slag which could be scraped off the heated or molten metal. In high-temperature metal processes, the primary purpose of flux is to prevent oxidation of the base material. The role of a flux is typically dual; that is, dissolving of the oxides on the metal surface and acting as an oxygen barrier by coating the hot surface, preventing its oxidation. A flux chemical is a substance which is nearly inert at room temperature, but which becomes strongly reducing at elevated temperatures, preventing the formation of metal oxides. Typical flux examples are borax, borates, fluoroborates, fluorides, and chlorides. Halogenides are active at lower temperatures than borates and are therefore used for aluminum and magnesium alloys. An example general reaction of oxide removal is:

Metal oxide+Flux(such as an Acid)→Salt+Water

The product of the reaction of a flux in a protective surface treatment and the surface oxide; that is, an oxide present or forming, is typically a salt or complex metal oxide. The protective surface treatment results in a reaction with molecular level iron oxide or iron oxyhydroxide on the surface of the steel. An example embodiment is boric acid reacting with the surface iron oxide or molecular surface iron oxide to form iron borate, according to the equation:

Fe₂O₃+2H₃BO₃→2FeBO₃+3H₂O

Another embodiment is the reaction of molecular or surface iron oxide or rust reacting with calcium fluoride to form:

Fe₂O₃.nH₂O+CaF₂→CaFe₂O₄+2HF

2FeO(OH)+CaF₂→CaFe₂O₄+2HF

In other embodiments, the product of the flux treatment reacts with a surface iron oxide to form at least one glass including a metal oxide, silicate, borosilicate, and/or alkali metal silicate. For example, boric acid and sodium borate as flux agents provides a glass which includes iron borate. A combination of boric acid and CaF2 as flux agents yields a glass including iron lime borate or iron calcium borate. A combination of boric acid and SiO2 as flux agents provides a glass including iron borosilicate. A combination of boric acid, calcium fluoride, and silica as flux agents provides a glass including iron calcium borosilicate. When CaF2 is the flux agent, the glass formed on the surface includes iron calcite glass. When SiO2 is the flux agent, the glass formed on the surface includes iron silicate glass.

The finished glass or glasses on the metal body can include a metal oxide, silicate, borosilicate, and/or alkali metal silicate, although in some cases the glass could flake off shortly after being formed.

Decarburization of the near surface region of the steel part occurs when a carbothermal reduction occurs. The reaction depletes carbon in the near surface regions of the steel component and occurs by reactions, such as:

2Fe₂O₃+3C→4Fe+3CO₂ (1)

Fe₂O₃+3CO→2Fe+3CO₂ (2)

These reactions occur by the reduction of Fe(lll) to iron metal (Fe° or Fe(0)) and oxidation of carbon to carbon dioxide. For example, the application of boric acid to the surface complexes the Fe(lll) and prevents the occurrence of the carbothermal reaction, thus preventing the decarburization of the near surface regions of the steel component. Addition of some agents, such as aluminum (Al), initiates an exothermic thermite reaction (see equation 3 below), also minimizing or eliminating the decarburization reaction.

2Al+Fe₂O₃→2Fe+Al₂O₃ (3)

According to the example embodiment, addition of carbon particles to the formulation will also minimize or eliminate the decarburization by converting the surface iron oxide to iron metal, as shown by reaction 1 above. With the addition of the carbon particles to the formulation, the source of carbon is external to the carbon within the steel or metal and, thus, the carbon within the steel or metal surface is not depleted. By this action, the decarburization will be minimized or eliminated. The carbon particles can be added as graphite, glassy carbon, or another form of carbon whereby the amount of the carbon is 0.25% to 15% weight percent. The size of the carbon particles can range from nanoparticles to particle diameters of 100 micron, preferably less than 5 microns, and more preferably sub-microns. The carbon particles added to the formulation are suspended in the solution. As an example, 2% of very fine graphitic carbon particles were added to a solution of 10% by weight of boric acid dissolved in ethanol which had been mixed with a solution of 8% by weight of an acrylate. In another example, 1% of very fine graphitic carbon particles were added to a solution of 20% by weight of boric acid dissolved in methanol which had been mixed with a solution of 14% by weight of an acrylate. As an example, 2.5% of very fine graphitic carbon particles were added to a solution of 22% by weight of boric acid dissolved in ethanol (note: ˜10% boric acid dissolves and ˜12% suspended) which had been mixed with a solution of 14% by weight of an acrylate.

Typical examples of flux agents include calcium fluoride (CaF₂) and boric acid. An example of mixture used for the surface treatment includes boric acid as the flux agent, polyvinylpyrrolidone (PVP) as the binder agent, methanol as the carrier agent, and carbowax as an additive. In this case, boric acid powder is dissolved in a solvent or carrier agent, blended with a binder powder/suspension agent, or boric acid is blended with a binder/suspension agent and then stirred into an alcohol or another volatile organic. Boric acid acts as the active agent or flux and is stirred into methanol or another solvent acting as the carrier agent. A binder powder, such as polyvinylpyrrolidone (PVP), or binder powder/suspension agent, such as hydroxypropyl cellulose (HPC) or carboxylmethyl cellulose (CMC), is stirred into the active/carrier solution (or mixture). Surface active agents, or surfactants, such as sodium lauryl sulfate, polyvinyl alcohol and carbowax, may be added to as a wetting agent or to maintain suspension of any solid phase. Lubricants, such as stearic acid, hexagonal boron nitride, molybdenum disulfide, etc., may be added to assist in consolidation of the components.

Typical examples of protective surface treatment formulations and steps of preparation include dissolving the active agent or flux in the carrier or solvent, dissolving the binder in the carrier or solvent followed by mixing the additive, and mixing the mixtures to the selected weight percentages of the active agent and binder. As an example, 10% by weight of boric acid dissolved in ethanol is mixed with a solution of 8% by weight of an acrylate (such as ethyl methacrylate, isobutyl methacrylate, tert-butyl methacrylate, or the mixture of acrylic acid, methyl methacrylate, ethyl acrylate, and ethyl acetate). In another example, 20% by weight of boric acid dissolved in methanol is mixed with a solution of 14% by weight of an acrylate. In some formulations, the percentage weight of boric acid is less than the solubility limit in the solvent whereby all of the boric acid is still in solution.

In some examples the active agent is additive beyond the solubility limit in the carrier or solvent, and, thus, the amount above the solubility limit is in suspension. In such cases the mixture is a suspension. As an example, 22% by weight of boric acid dissolved in ethanol (note: ˜10% boric acid dissolves and ˜12% suspended) is mixed with a solution of 14% by weight of an acrylate and 2% by weight of BYK-420. In another example, 16% by weight of boric acid dissolved in ethanol (note: ˜10% boric acid dissolves and ˜6% suspended) is mixed with a solution of 6% by weight of an acrylate and 2% by weight of BYK-420.

If the boric acid is added as a solid to the solvent, such as ethanol, then it is preferable that the binder is added and dissolves first, before the boric acid is added.

Another example of a protective surface treatment mixture is as follows:

Step 1: Add acrylate copolymer binder, 12% by weight, to ethanol carrier

Step 2: Add boric acid, 17% by weight, to ethanol carrier/acrylate binder system (note: ˜40% boric acid dissolves & ˜7% suspended)

Step 3: Add an additive, such as BYK420 or a surfactant, <1-5% by weight, to carrier/binder/active agent

The additive can be added after any step but is typically added after step 1.

Boric acid is a white or clear-colored, odorless, and tasteless crystalline solid. There are three types of boric acids; namely, orthoboric acid (H₃BO₃), metaboric acid (HBO₂), and pyroboric acid (H₂B₄O₇). It is sparingly soluble in cold water and fairly soluble in hot water. Boric acid is a very weak monobasic acid, as shown in the following equation:

B(OH)₃+H₂O→B(OH)4⁻+H⁺ (4)

Boric acid has a melting point of 171° C. and a boiling point of 300° C. (with decomposition). When heated, boric acid forms metaboric acid at 100° C., pyroboric acid at 140° C., and boron oxide at 300° C., as shown in the following equations:

At 100° C.: H₃BO₃→HBO₂+H₂O (metaboric acid) (5)

At 140° C.: 4HBO₂→H₂B₄O₇+H₂O (pyroboric acid) (6)

At 300° C.: H₂B₄O₇→2B₂O₃+H₂O (boron oxide) (7)

Boric acid will initially decompose into water steam and metaboric acid. Boric acid will initially decompose into water steam and metaboric acid (HBO₂) at around 170° C., and further heating above 300° C. will produce more steam and boron trioxide. The reactions are:

H₃BO₃→HBO₂+H₂O (8)

2HBO₂→B₂O₃+H₂O (9)

When boric acid is heated slowly, it loses water and converts to metaboric acid.

Metaboric acid has three different crystal modifications:

Orthorhombic metaboric acid: (melting point: 176° C.)

Monoclinic metaboric acid: (melting point: 200.9° C.)

Cubic metaboric acid: (melting point: 236° C.)

When the dehydration temperature is below 150° C., the boric acid is always in the form of metaboric acid. Above 150° C., the boric acid loses all its water and transforms to boron oxide (B₂O₃). Crystalline boron oxide has a melting point of 450° C., but amorphous boron oxide does not have a specific melting temperature. Amorphous boron oxide starts to soften at 325° C. and becomes fluid at 500° C.

After dehydration of boric acid (H₃BO₃), boron oxide (B₂O₃) forms. Boron oxide has many different application areas due to its superior physical and chemical properties. Boron oxide is a main constituent in the production of organic and inorganic boron compounds like elemental boron, metal borates, and boric acid esters. It is also used as a catalyst in the production of organic compounds and as a fluxes in metallurgy. In addition, boron oxide is also used in glass, glass fibers, optical fibers, ceramics, metal coatings, boron alloys, electronic industry, and fire retardants. Boric acid is a mild acid which is relatively non-toxic to humans and non-carcinogenic, and has a wide variety of uses in the home. It also is used in cosmetic and pharmaceutical products, in pest control, and even in manufacturing.

Compositions which are possible formations as protective surface components on the treated steel are compositions known in the ternary Fe—B—O system. Such compositions are as follows:

Under ambient-pressure conditions:

| | |
|---|---|
| Fe^{II}₂Fe^{III}(BO₃)O₂ | Trigonal-planar BO₃ groups |
| Fe^{II}Fe^{III}₂(BO₄)O₂ | BO₄ tetrahedra |
| Fe^{II}Fe^{III}(BO₃)O | Trigonal-planar BO₃ groups |
| FeB₄O₇ | BO₃ groups and BO₄ tetrahedra |
| FeBO₃ | Trigonal-planar BO₃ groups |

High-pressure/high temperature syntheses of iron borates:

| | |
|---|---|
| β -FeB₄O₇ | Corner-sharing BO₄ tetrahedra |
| α- FeB₂O₄ | Corner-sharing BO₄ tetrahedra |
| β-FeB₂O₄ | Solely BO₄ tetrahedra |
| Fe₂B₂O₅ | Pyroborate |

Boric acid is used by many industries, with the largest use in the glass and ceramic industry where it is mainly used in textile grade glass fibers, borosilicate glasses, enamels, frits and glazes. In these applications, boron accelerates melting and refining, enhances color, increases resistance to mechanical and thermal shock, decreases the thermal expansion coefficient, reduces glaze viscosity and surface tension and enhances the glaze strength and durability. Boric acid also has many other application areas, such as fire retardant material, in nuclear applications, in medical and pharmaceutical sector, in photography, and in the electronics sector. In addition, boric acid is a starting material for the manufacture of many borates, per borates, fluoborates, boron carbide, boron oxide, boron esters, borides and other boron alloys.

The binder or vehicle agent holds the flux agent in the surface region allowing it to perform its function, acts as an oxygen barrier to protect the hot metal surface against oxidation, dissolves the reaction products of the active chemicals and oxides and carries them away from the metal surface, and facilitates heat transfer. The binder or vehicle agents typically form networks similar to polymeric structures. Preferable binder agents include PVP or Polyvinylpyrrolidone polymers, vinylpyrrolidone/vinyl acetate (VP/PA) copolymers, PVP/VA copolymers (S630 and E335), hydroxypropyl cellulose G (Klucel G), hydroxypropyl cellulose L (Klucel L), hydroxypropyl cellulose E (Klucel E), Benecel A4M, Benecel K100M, and Ethylcellulose N-200.

Preferable binder agents include any acrylate, acrylic acid, and acrylic copolymer or any acrylate and acrylic acid that forms an acrylic copolymer, whereby the acrylate or acrylic acid or acrylate copolymer is soluble in any solvent that can dissolve or suspend a flux agent such as boric acid, borax, or any boric acid or boron oxide forming chemicals. Examples of acrylate resins that work well as binders in the preparation of the protective surface treatment mixture are methacrylate copolymer such as Elvacite 2028, ethyl methacrylate such as Elvacite 2043 or Dianal BR-220, isobutyl methacrylate such as Elvacite 2045, butyl methacrylate such as Dianal BR-115, acrylate resin TB-0044 from Dianal, and tert-butyl methacrylate. Another binder example is the mixture of acrylic acid (5 to 60% by weight), methyl methacrylate (5 to 60% by weight), ethyl acrylate (5 to 60% by weight), and ethyl acetate (1 to 10% by weight). A preferred mixture is 15% acrylic acid, 40% methyl methacrylate, 40% ethyl acrylate, and 5% ethyl acetate.

Acrylate, acrylic acid, and acrylic copolymer or any acrylate and acrylic acid that forms an acrylic copolymer (such as ethyl methacrylate, isobutyl methacrylate, tert-butyl methacrylate, or the mixture of acrylic acid, methyl methacrylate, ethyl acrylate, and ethyl acetate) are preferable binders that are moisture resistant in the deposited state on the surface of the steel.

PVP K-15 and PVP K-30 properties have shown promising results in a specialty coating where the PVP is a binder and promotes adhesion. However, moisture adsorption can be a problem. In addition to possible problematic moisture adsorption due to the PVP, viscosity generated from the PVP K-15 and PVP K-30 is lower. PVP/VA, hydroxypropyl cellulose (HPC), and Ethylcellulose (EC) are preferable binders that have more favorable moisture resistant properties. Summarized immediately below is a sampling of TGA data for moisture adsorption of several polymers at varying humidity levels. PVP/VA copolymer, Klucel HPC E, and EC have a lower adsorption compared to PVP. HPC E and EC should have excellent methanol solubility. Moisture adsorption of HPC E is <10% at 90% humidity and EC<5% at >80% humidity. PVP/VA E-335 is slightly >10% at 84%.

TABLE 1
Moisture Adsorption (%) at different humidity levels @25° C.

| | | | PVP/VA | PVP/VA | Benecel | Benecel | | |
|---|---|---|---|---|---|---|---|---|
| Humidity | HEC | PVP | S630 | E335 | A4M | K100M | Klucel E | EC |
| 20 | | 10 | | | 3 | | | ~0.5 |
| 50 | 6 | 19 | 7 | 4 | 7 | 7 | 2 | |
| 84 | 29 | 31 | 25 | 13 | 16 | 17 | 6 | ~3 |

Preferable binder agents include the following:

PVP K-15

PVP D-30

PVP/VA S-630

PVP/VA E-335

Klucel G

Klucel L

Klucel E

Ethylcellulose N-200

Cross-linkers as additives will prevent the moisture absorption and are preferable for the binder. Additive targets include:

Good solubility in methanol

Low moisture adsorption (PVP moisture adsorption is too high)

Coating is temporary (e.g. 1-2 months)

Coating stability to 150 F

Relatively clean burning

Affinity for substrates

Binding capability

PVP/VA, (Klucel E), and Ethylcellulose are preferable binders that have more favorable moisture resistant properties.

PVP or Polyvinylpyrrolidone polymers, also commonly called polyvidone or povidone, are a water-soluble polymer made from the monomer N-vinylpyrrolidone. The preferred binders include, not only PVP polymers, but also PVP/VA (polyvinylpyrrolidone/vinyl acetate copolymers), hydroxypropyl cellulose (HPC), carboxylmethyl cellulose (CMC), hydroxyethyl cellulose (HEC), other cellulose complexes under the trade name Klucel, stirred into the active/carrier solution (or mixture).

PVP polymers are commercially available in several viscosity grades, ranging from low to high molecular weight. Example PVP polymers are available from Ashland, Inc., Covington, Ky. This range, coupled with solubility in aqueous and organic solvent systems, combined with its nontoxic character, make it an agent very suitable as a binder system. Although the molecular weights range from 4,000 to 3,000,000 g/mol, the polymers with molecular weights ranging from 4,000 to 80,000 are preferable, with the lower molecular weights more preferable, such as the PVP polymer grades K-12, K-15, and K-30. In organic solvents, the viscosity of the solution is related to that of the solvent, such as viscosities of K-30 in ethanol are 2 and 6 centistokes and in isopropanol are 4 and 12 centistokes for 2% PVP and 10% PVP, respectively. The PVP polymer viscosity values do not change appreciably over a wide pH range. PVP K-30 polymer is also freely soluble in many organic solvents, including alcohols, some chlorinated compounds such as chloroform, methylene chloride and ethylene dichloride, nitroparaffins, and amines. It is essentially insoluble in hydrocarbons, ethers, some chlorinated hydrocarbons, ketones and esters. Dried unmodified films of PVP polymer are clear, transparent, glossy, and hard. Appearance does not vary when films are cast from different solvent systems, such as water, ethanol, chloroform, or ethylene dichloride.

Compatible plasticizers may be added without affecting clarity or luster of the film. Moisture taken up from the air by PVP polymer can also act as a plasticizer. It should be noted that one issue is the green or “as deposited” coatings may absorb moisture. This is not a problem after heat treatment, since the resultant coating does not absorb moisture. Among the several commercial modifiers that may be used in concentrations of 10-50% (based on PVP polymer) to control tack and/or brittleness or to decrease hygroscopicity are: carboxymethylcellulose, cellulose acetate, cellulose acetate propionate, dibutyl tartrate, diethylene glycol, dimethyl phthalate, 2-ethylhexanediol-1, 3, glycerin, glycerylmonoricinoleate, Igepal CO-430 (Solvay), oleyl alcohol, Resoflex R-363 (Broadview Technologies), shellac, and sorbitol.

Carboxymethylcellulose, cellulose acetate, cellulose acetate propionate, and shellac effectively decrease tackiness. Dimethyl phthalate is less effective, whereas glycerin, diethylene glycol, and sorbitol increase tackiness. Films essentially tack-free over all ranges of relative humidity may be obtained with 10% arylsulfonamide-formaldehyde resin.

In comparative tests for plasticity at 33% relative humidity, PVP polymer films containing 10% diethylene glycol show an “elongation at break” twice that of PVP polymer films containing 10% glycerin, polyethylene glycol 400, sorbitol, or urea, and four times that of PVP polymer films containing 10% ethylene glycol, dimethyl phthalate. At 70% relative humidity, 25% sorbitol and 25% dimethylphthalate may be used successfully.

PVP polymer shows a high degree of compatibility, both in solution and film form, with most inorganic salt solutions and with many natural and synthetic resins, as well as with other chemicals.

The best viscosity grade to use depends on the application, and in some cases, the lower molecular weight polymers, PVP K-15 polymer or PVP K-30 polymer, are more efficient than high molecular weight material. For example, PVP K-15 polymer is particularly effective as a dispersant for carbon black and low bulk density solids in aqueous media. PVP K-90 polymer is most suitable, e.g., as a dispersant for organic pigments and latex polymers in emulsion paints and is preferred as the protective colloid in the suspension polymerization of styrene to generate the desired particle size.

PVP polymers form molecular adducts with many other substances. This can result in a solubilizing action in some cases or in precipitation in others. PVP polymer crosslinks with polyacids like polyacrylic or tannic acid to form complexes which are insoluble in water or alcohol but dissolve in dilute alkali. Gantrez™ AN methyl vinyl ether/maleic anhydride copolymer, will also insolubilize PVP polymer when aqueous solutions of polymers are mixed in approximately equal parts at low pH. An increase in pH will solubilize the complex.

Ammonium persulfate will gel PVP polymer in 30 minutes at about 90° C. These gels are not thermoreversible and are substantially insoluble in large amounts of water or salt solution. The more alkaline sodium phosphates will have the same effect. In alcoholic solution, no precipitation of PVP takes place. Under the influence of actinic light, diazo compounds and oxidizing agents, such as dichromate, render PVP polymer insoluble. Heating in air to 150° C. will crosslink the PVP polymer and strong alkali at 100° C. will permanently insolubilize the polymer.

Since the PVP powder is hygroscopic, suitable precautions should be taken to prevent excessive moisture pickup. Bulk polymer is supplied in tied polyethylene bags enclosed in fiber packs. When not in use, the polyethylene bag should be kept closed at all times in the covered container. On PVP polymer films, moisture acts as a plasticizer. These films are otherwise chemically stable. The equilibrium water content of PVP polymer solid or films varies in a linear fashion with relative humidity and is equal to approximately one-third the relative humidity. Some darkening in color and decreased water solubility are evident on heating in air at 150° C. However, PVP polymer appears to be quite stable when heated repeatedly at 110 to 130° C. for relatively short intervals.

PVP improves dye receptivity of such hydrophobic fibers as polyolefins, viscoses, rubber latices, polyacrylonitriles, and acrylics. In such application, there is good compatibility and crosslinking properties. PVP has an ability to complex with a broad variety of compounds. PVP is used in the polymerizations of acrylic monomers, unsaturated polyesters, olefins, including PVC, styrene beads, substrate for graft polymerization, and template in acrylic polymerization.

Hydroxypropyl cellulose (HPC) is a nonionic water-soluble cellulose ether with a remarkable combination of properties, i.e., soluble in organic solvents, thermoplasticity, and surface activity. The HPC is available from Ashland Specialty Ingredients as Klucel products. To decrease moisture absorption sensitivity, types with lower molecular weights are used. Thus, Klucel G and Klucel L are used, with type L more preferable.

Ethyl cellulose is a derivative of cellulose in which some of the hydroxyl groups on the repeating glucose units are converted into ethyl ether groups. Ethylcellulose is a film-forming cellulose ether classified into four ethoxyl types and into a range of polymer viscosities for ease of use. Ethyl Cellulose does not dissolve in water, but is soluble in many organic solvents. It is soluble in aromatics such as benzene, toluene, ethylbenzene and xylene at 60-80%, and alcohols, such as methanol and ethanol at a 20-40% level. It can be added to the organic solvent slowly with stirring until completely wet and dissolved.

Ethyl cellulose is widely used in a variety of paints, surface coatings, such as metal, paper products, paints, rubber coating, hot melt coating, and integrated circuits. It is also used for ink, such as magnetic ink, the specialty plastics and special deposits, such as rocket propellant coating, insulation and cable coatings, suspension polymerization of polymer dispersant, carbide and ceramic adhesive, the textile industry for printing paste, and other applications.

Ethylcellulose (EC) is a hydrophobic ethyl ether of cellulose. It is a non-toxic, stable, compressible, inert, hydrophobic polymer. EC is also predominantly used in food supplements and flavorings, can function as an emulsifier to stabilize water-oil-mixtures, shows good thermo stability and electric properties, and is a non-bio degradable, bio-compatible, non-toxic natural polymer widely used in oral and topical formulations.

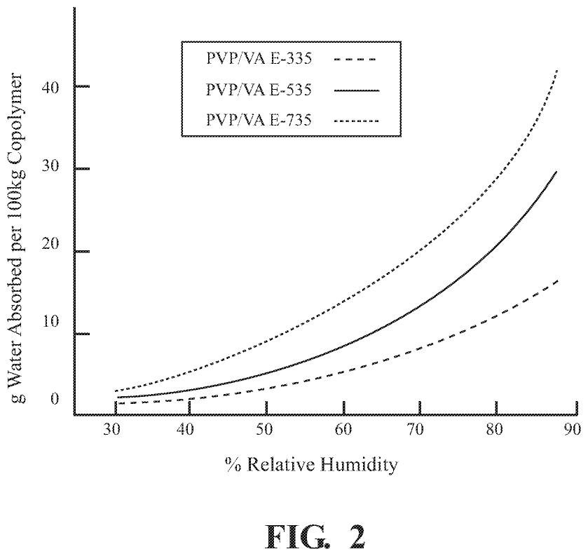

The vinylpyrrolidone/vinyl acetate (VP/PA) copolymers have members in the PVP/VA copolymer series that serve as primary film formers in a variety of products demanding different degrees of water resistance. These copolymer films feature specific affinities and smooth surfaces on metal. The PVP/VA series of thermoplastic copolymers have Tg properties as a function of vinylpyrrolidone (VP) content. For example, 70, 60, 50, and 40 wt % VP have Tg (° C.) values of 109, 105, 73, and 55, respectively. Unmodified copolymers having the lower ratios of vinylpyrrolidone to vinyl acetate exhibit more moisture resistance than products with high ratios of VP to VA. VA (vinyl acetate) is a more hydrophobic molecule than VP (vinylpyrrolidone). Thus, increasing VA content of the copolymer causes an increase in hydrophobicity and consequently a decrease in water solubility and hygroscopicity relative to the VP homopolymer. The inherent water sensitivity of PVP/VA copolymer films varies with the monomer ratio. Typical data is shown in the graph of FIG. 2 for PVP/VA E-735, PVP/VA E-535 and PVP/VA E-335. The data includes relative hygroscopicity of (at equilibrium) of PVP/VA copolymer films. In general, PVP/VA is less hygroscopic than PVP, and the E-335 PVP/VA is more preferable for its more favorable water resistance.

Most PVP/VA copolymers are compatible with a variety of nonionic and cationic polymers. PVP/VA S-630 is a white, odorless powder at 60/40 VP/VA weight ratio. It is a high molecular weight, solvent and water soluble copolymer exhibiting a minimal critical solution temperature of approximately 70° C.

Members of the PVP/VA copolymer family have been well studied in numerous acute, sub-chronic and chronic toxicity studies in animals, as well as in human skin clinical testing. Results indicate that these copolymers demonstrate a low order of acute oral toxicity and are neither primary dermal irritants nor sensitizing agents. Chronic studies demonstrate no adverse effects following both oral administration in the mouse and rat and inhalation in the rabbit and hamster. Based on these data, the Expert Panel of Cosmetic Ingredient Review has concluded that “Polyvinylpyrrolidone/Vinyl Acetate copolymer is safe as a cosmetic ingredient under present conditions of concentration and use.”

In an attempt to decrease the moisture sensitivity of PVP and cellulose materials as a coating in the green state, cross linking is a possible approach. Cross linking PVP is normally accomplished by using copolymerized vinyl pyrrolidone (VP) with an aminoalkene or cross-linking in situ with additives such as pentaerythritol triallyl ether (PETE).

Summarized below is historical information and a listing of potential cross-linking reactants for derivatized cellulosics with hydroxyl functionality such as Klucel (hydroxypropyl cellulose). Cross-linking additives must be reactive with hydroxyl functionality. The list includes 1,2-dichloroethane, 1,2-dibromoethane, dibromomethane, dichloromethane, epichlorohydrin, diglycidyl ether, ethylene glycol diglycidyl ether, ethylene glycol vinyl ether, divinyl sulfone, 1,4-benzoquinone, Kymene 2064—poly(diallylamine)epichlorohydrin, and ethylene glycol ditosylate.

Cure rate is dependent on the reactivity of the crosslinking agent, temperature, pH, and concentrations of polymer, and cross-linker. High temperature, low pH, and higher proportions of resins tend to increase the rate of cure, improve water resistance, and increase stiffness.

When heat curing, Klucel can be sufficiently reactive to crosslink in the absence of catalysts at neutral pH. Utilization of a melamine-formaldehyde resin (e.g., Aerotex M-3) with hydroxypropyl cellulose solution is an example. The films shown in Table 2 below were cast from 4% solutions of hydroxypropyl cellulose (Klucel G) with dry films 0.1 mm. Dimethylol urea (DMU) was also reactive and resulted in insoluble films.

TABLE 2
Insolubilizing G-Type film with resins
under heat-curing (5 minutes at 150° C.)

| | Concentration | | | |
|---|---|---|---|---|
| | based on | | | Water |
| | weight of | | | insoluble* |
| Resin | Klucel | Solvent | pH | (%) |
| Control | Nil | Water | 6.3 | Nil |
| Dimethylolurea | 10 | Water | 5.9 | 96 |
| (DMU) | | | | |
| Aerotex M-3 | 10 | Water | 6.3 | 94 |
| Quilon S** | 5 | Water | 2.5 | 90 |
| Quilon S | 5 | Methanol | — | 88 |
| Quilon S | 5 | Methyl- | — | 89 |
| | | cellosolve | | |

*Water insoluble test: Cured films tumbled 20 hours in water at pH 7.0. Residual film weight noted.
**Quilin S is Stearatochromyl chloride complex.

Room-temperature curing can also be sufficiently reactive with hydroxypropyl celluloses to provide crosslinking after one day. DMU resin is preferred. An acid catalyst, such as para-toluene sulfonic acid, is required for cross-linking to occur at room temperature. A solution containing 10% hydroxypropyl cellulose (Klucel L) and 0.5% DMU resin and 0.025% para-toluene sulfonic acid at pH 3.0 cast as a 1 mm wet film was dried in a current of air and stored for 24 hours at room temperature. The film was then 98% insoluble in water. See Table 3 below.

Crosslinking of HPC can also be targeted by esterification of HPC using adipoyl chloride where adipoyl chloride is added to a HPC solution in tetrahydrofuran (THF) added slowly and then allowed to form the gel HPC film in 3 to 4 days.

TABLE 3
Insolubilizing L-Type film with resins and
catalyst* and curing at room temperature.

| | Concentration | | | | |
|---|---|---|---|---|---|
| | based on | | | | |
| | weight of | | Water insoluble*** (%) | | |
| Resin | Klucel | pH** | 1 day | 2 days | 3 days |
| Control | Nil | 6.5 | Nil | Nil | Nil |
| Dimethylolurea | 5 | 3.0 | 98 | 98 | 98 |
| (DMU) | | | | | |
| DMU | 5 | 4.0 | 65 | 90 | 95 |
| DMU | 5 | 6.2 | 1 | — | — |
| DMU | 15 | 2.5 | 99+ | — | — |
| Cymel 301**** | 5 | 3.2 | 88 | — | — |
| Cymel 301 | 5 | 2.6 | 97 | — | — |
| Cymel 301 | 15 | 2.6 | 97 | — | — |

*Catalyst was para-toluene sulfonic acid added at 5% by weight of insolubilizing resin. Water as the solvent in all cases.
**Where necessary, solutions were adjusted with HCI or NH4OH to attain pH value shown.
***Water insoluble test: Cured films tumbled 20 hours in water at pH 7.0. Residual film weight noted.
****Cymel 301 is Hexamethoxymethylmelamine.

A method of forming the protective surface treatment in the form of a coating, for steel or another metal or metal alloy, and a method of manufacturing a component formed of steel or another metal or metal alloy using a surface treatment is provided by the subject invention.

There are several key aspects of producing the surface treatment process and resultant materials for application to steel, metal, or metal alloy components in order to provide a protective surface during manufacturing and thereafter. The first is surface preparation of the steel or metal substrate, which is important to get a good interface with good adhesion. The surface preparation treatments are available from a commercial vendor, such as Bulk Chemicals. The surface preparation treatments can use the ZircaSil technology, a metal pretreatment designed to replace traditional iron and zinc phosphates. The homogeneous inorganic coating forms a layer of a nano-metallic matrix on metal surfaces that is uniform and protective, and thinner than iron and zinc phosphates. The treatment can be applied by spray or immersion process and can be used for virtually all metals. Advantages include faster process times, fewer chemicals, lower energy costs and lower water usage.

Surface preparation is required prior to applying the mixture. The condition of the steel or metal surface to which the mixture is applied is the most critical step in the success of the coating bonding to the surface. The surface preparation required before coating can be accomplished by the following items.

1. Removal of oils that is normally present on uncoated steel to prevent atmospheric corrosion during shipping and storage. Several methods and combinations of methods can be used. One method includes solvent degreasing, wherein the solvents used are acetone and MEK. The solvents remove the majority of the oils, but further removal is accomplished by cleaning the surfaces with alkali solutions. These include the use of alkalis such as NaOH and KOH. Typical concentration of the alkali solutions is 1-5%. The alkali solutions work better if they are further modified by surfactants for improved wetting of the oily surfaces which have high water contact angels with reduced uniform wetting. It is also noted that the alkali oil removal action is further enhanced by using hot solutions at temperatures in the range of 125-175° F. Once the alkali solutions are used. It is critical that any excess is removed and it is accomplished by using clean water heated to 125 to 150° F.

2. Surface Activation: The removal of oils only removes the surface layer that is not chemically bonded to steel. However, the surface under the oily surface still has a thin layer of surface oxide that needs to be removed for better bonding of the coatings to the steel surface. The surface activation is accomplished by mechanical and chemical methods

The mechanical methods include processes such as abrading lightly using scotch bright pads, wire brushes, blasting using alumina particles, sand particles, or glass beads.

The chemical methods of activation include processes such acid etching and coatings consisting of zinc phosphate (which requires a pre-coat of titanium and a post coat of chromium coating to seal in the zinc phosphate).

Several steel panels of 4×6 in size can be prepared by a commercial vendor, such as Bulk Chemicals.

Cleaning of the substrate was based on Bulk Kleen® 841 MC at 2% by volume concentration and 165° F. with a 5 second spray, brush, and 5 second spray cleaning sequence. Using this sequence, it was found that a water break free surface was not attainable. Examination of the “cleaned” substrate showed that there was still heavy smut associated with the surface. A water break free surface can be produced with an addition of 0.1% Bulk Sol 27AM and Bulk Sol 30 to the cleaner bath. Additionally, several substrates were also cleaned using Bulk Kleen® 841 (2%, 165 F) with brushing and coating with various coating weights of Bulk Bond® NP250.

After cleaning the substrate or panels and achieving a water break free surface, the panels were post treated with the following treatments:

1. NP-250 (chrome DIP)

2. E-2950SI chrome free DIP

3. E-1700

4. E-1980

5. BB780 (iron phosphate), rinse, NP-250

6. BB780, rinse, E-2950SI

7. BB780, rinse, E-1700

8. Zircasil 100, rinse, NP-250

9. Zircasil 100, rinse, E-2950SI

10. Zircasil 100, rinse, E-1700

11. BB312 after activator, rinse, NP-250

12. BB312 after activator, rinse, E-2950SI

13. BB312 after activator, rinse, E-1700

Zirca-Sil MS3 by Bulk Chemicals is a single-step, zirconium-based, phosphate-free pretreatment developed to replace conventional clean-and-coat phosphate pretreatments. It can operate at ambient temperatures for most soil conditions or at higher temperatures for more severe conditions. The pretreatment is virtually sludge-free and non-hazardous, and can be used in as few as two-stage washers. According to Bulk Chemicals, it can be used on virtually all substrates, and, under most paints, corrosion resistance is improved over conventional cleaner/coater iron phosphate.

Bulk Chemicals, ZircaSil technology, a metal pretreatment, is designed to replace traditional iron and zinc phosphates. This homogeneous inorganic coating forms a layer of a nano-metallic matrix on metal surfaces that is uniform and protective, and thinner than iron and zinc phosphates, but equal in performance, as tested by Bulk Chemicals. It can be applied by spray or immersion process and can be used for virtually all metals. Advantages include faster process times, fewer chemicals, lower energy costs and lower water usage.

After the above surface preparation, a post surface preparation treatment is conducted. After the surface has been prepared by the combination of steps listed above, there is a strong possibility for the water vapor to be adsorbed on the surface. This adsorbed layer needs to be removed before the coating application, to make sure that during the post processing of the mixture at high temperatures, the adsorbed water does not build pressure at the steel/coating interface that will cause the coating to be de-bonded. The best way to address this issue is to bake the surfaces that have been prepared to temperatures of 250° F. prior to coating them. The preheated surfaces also give the advantage of rapid drying of the mixture when applied by spray or a roll coating process.

Bulk Kleen® line of alkaline cleaners do an excellent job of removing oils and soils from all metal substrates. Bulk Kleen® line of products virtually eliminates the need to acid clean your cleaner process tanks in order to remove scale.

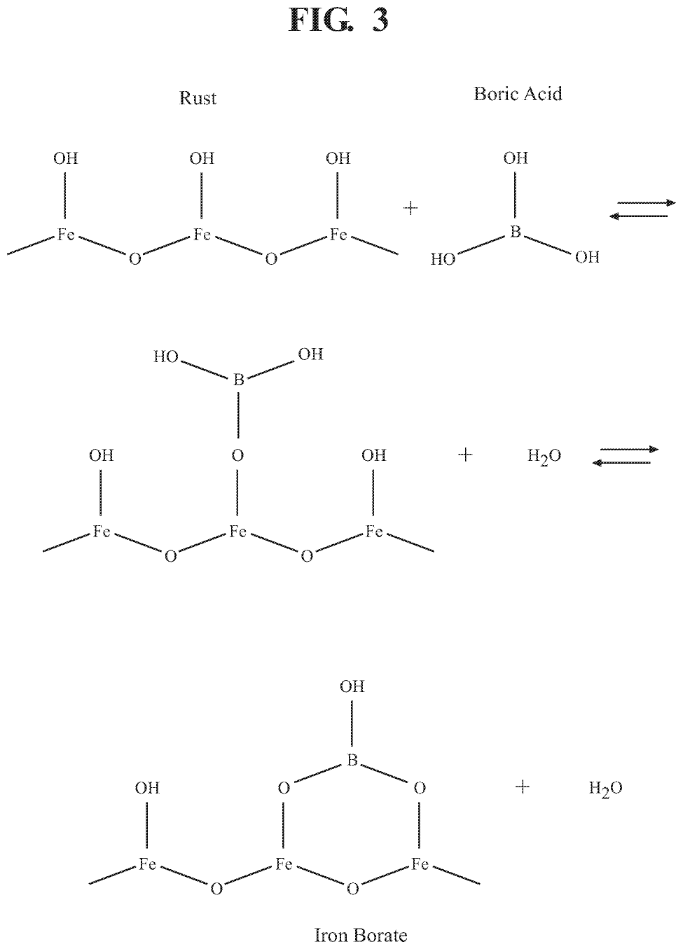

After the surface has been degreased and the oxide removed from the steel surface, or after using one of the surface treatments shown above, the coating solution, mixture, or slurry should be deposited immediately. However, it should be noted that the presence of a slightly oxidized or uniform oxidized-covered surface can actually aid in the formation of a protective surface. As an example, an oxidized or slightly oxidized iron-containing surface contains rust, hydrated iron (III) oxides and iron (III) oxide-hydroxide, shown as Fe₂O₃.nH₂O or typically Fe₂O₃.2H₂O and often expressed as FeO(OH). Fe(OH)₃. Boric acid adsorbs onto the surface of rust to form a borated iron complex shown by reactions in FIG. 3.

The slurry chemistry, composition, and deposition process is also very important to getting a uniform, controlled, repeatable coating control or prevent oxidation during heating in the manufacturing process. A pre-heat treatment, applied after deposition of the surface protective coating, is to cure or bake, at typically about 100-600° C., to remove the carrier and, in some cases, the binder, to form the protective coating. Thus, heat treatments, applied after deposition of the surface protective coating include heating at 100 to 600° C., typically 400° C., to completely evaporate and remove the carrier, followed subsequently by final heat treatments at 700° C., 880° C., and 930° C., followed by air or tool quenching. More preferably, the final heat treatment is completed during steel processing, such as hot stamping and tool quenching.

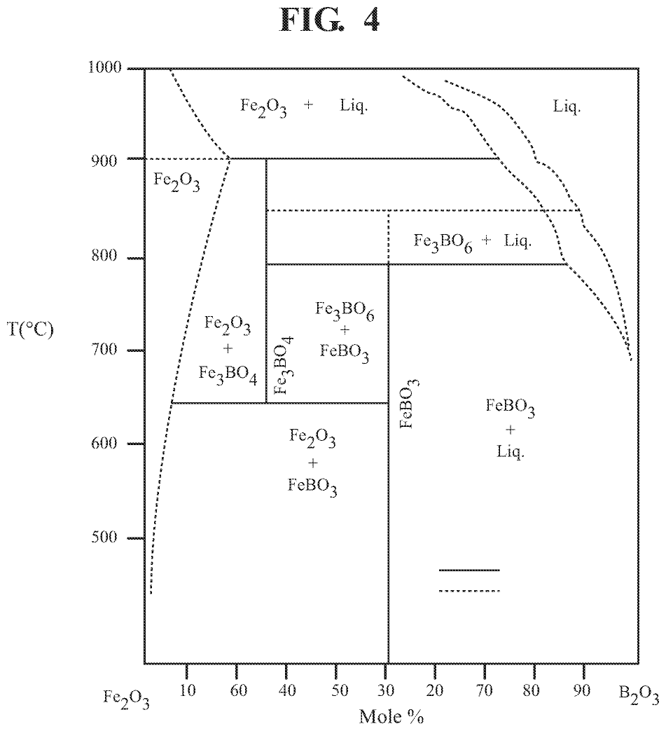

Since B₂O₃ is formed when boric acid is heated, according to Equations 8 and 9, the surface iron oxide reacts with boron oxide. A phase diagram of the binary system Fe₂O₃—B₂O₃ is shown in FIG. 4. The phase diagram of the binary system Fe₂O₃—B₂O₃ was conducted by Markam et al. and modified by this study. The ., ( ), and A indicates experimental points Fe₂O₃ identified only, Fe₃BO₆ identified, and FeBO₃ identified respectively.

The process described here, which includes a glass forming treatment, and the glass forming treatment is a unique surface treatment process that provides the following key benefits: replaces oil treatment to prevent rusting of steel; forms glassy phases when heated to 300-1200° C.; the glassy phases reduce the steel substrate oxidation during high temperature heating in air and inert atmospheres; the glassy phases allow hot die forming of complex steel shapes without spallation; the glassy phases are sufficiently thin to not affect the part quench rates and thus full benefits of properties in steel parts are achieved; the glassy phases are lubricious at hot forming temperatures to reduce the forming loads; the lubricity of the glassy phases reduces the die wear; by preventing the oxidations, the glassy phases also minimize any decarburization of steel; the glassy phases have no effect on the welding of the components; the glassy phases on the formed parts provide corrosion protection at ambient conditions and thus not requiring any post part shot blasting and oiling; since glassy phases result in the quenched microstructure, no change in the mechanical properties are noted; the formed parts with the glassy phase require minimum cleaning for post e-coat; the treatment results in large cost savings from all of the benefits listed above.

The process described here is also beneficial because no shot blasting is required of the hot stamped parts as is the case on parts formed without the process; no oiling of parts required as is the case for shot blasted parts without the process; no decarburization occurs; low friction surfaces with improved die life and improves dimensional control of the parts are produced; hot stamped parts of the treated steel can be E-coated without having to removal oil as is the case with parts formed without the process. The process also produces improved welding including lap joints and fastener joining; produces no decarburization of the hot stamped parts; has no detrimental effects on tensile properties of as hot stamped parts; has no detrimental effects on bend properties of hot stamped parts. The process also provides the following benefits when used on uncoated high strength steel for the following benefits: prevents oxidation during heating at 930-950° C., prior to hot stamping; the process suitable for heating in controlled atmosphere furnaces, where protective atmosphere is nitrogen; the process may also be suitable for heating in air furnaces; application methods of the treatment include spraying, painting, and on-line roller application; samples treated are thermally cured by heating at 200-400° F.; the coating is a green coating in the as applied and thermally cured condition; the coating thickness is 6-8 g/m², and it transforms to a protective coating during the heating process prior to hot stamping.

There are several mechanisms for the formation of the protective surface during the treatment process. Two possible mechanisms are outlined by the following reactions:

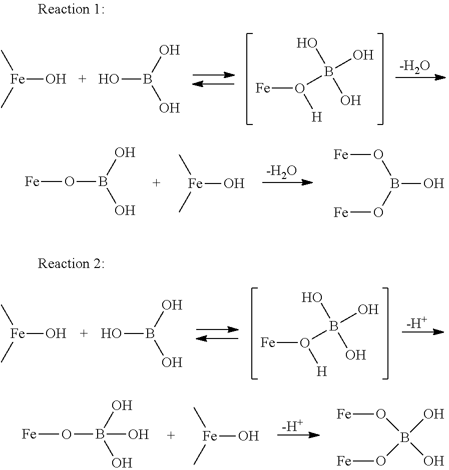

To reduce decarburization, the coating should form a protection film and produce nitrogen gas when heated. The coating should also provide protection in an air atmosphere. The chemical solution can continue to perform the following reaction:

Chemical X+chemical Y+chemical Z→H₃BO₃+N₂+C (heating up to 940° C.)

Chemical X—Borax Na₂B₄O₇.10H₂O or Na₂[B₄O₅(OH)₄].8H₂O

Chemical Y—Ammonium chloride ClH₄N

Chemical Z—Sodium carbonate Na₂CO₃

The following chemical reactions can occurring during heating:

NH₄Cl→NH₃+HCl

NH₃+Fe₂O₃→Fe+H₂O+N₂

Na₂B₄O₇.10H₂O+2 HCl→4H₃BO₃+2NaCl+5H₂O

Na₂CO₃+HCl→NaCl+H₂O+C

According to another example embodiment, the following reaction may occur:

NH₄Cl+Fe₂O₃+Na₂B₄O₇.10H₂O+Na₂CO₃→Fe+H₃BO₃+H₂O+N₂+C

N₂ and C are able to reduce decarburization. H₃BO₃ are able to form a protection film. The following reaction can also be used to produce H₃BO₃:

Na₂B₄O₇.10H₂O+2HCl→4H₃BO₃+2NaCl+5H₂O

The following are additional examples of the protective surface treatment process.

### EXAMPLES

### Example 1. Effect of Binder Concentration on the Quality of Coated Surface with a Fixed Amount of Boric Acid

In this example, a 20% solution of boric acid in methanol was prepared. To this solution 10, 12, 14, 16, 18, and 20% of 31% solution of PVP in methanol (or 3.1, 3.72, 4.34, 4.96, 5.58, and 6.2% of PVP) was added. For each solution composition, steel samples of 2×3-in and of 0.071-in thickness were spray coated. Coating amount on each side and coating weight per side (g/m²) are summarized in Table 4. Table 4 includes data for coating details when a solution of 10% boric acid and varying amounts of PVP solution are sprayed on 2×3-in steel samples of 0.071-in thick

TABLE 4
Data for coating details when a solution of 10% boric acid and varying amounts
of PVP solution are sprayed on 2 × 3-in steel samples of 0.071-in thick

| | | | | | Coating | Coating | Coating | Coating |
|---|---|---|---|---|---|---|---|---|
| Boric | PVP | Sample | Sample | Sample | Weight | Weight | Weight | Weight |
| Acid | Solution | Weight | Weight | Weight | Side1 | Side2 | both Sides | per side |
| (%) | (31%) | (g) | (g) | (g) | (g) | (g) | (g) | (g/m\hat{ }2) |
| 10 | 10 | 55.1939 | 55.2400 | 55.2828 | 0.0461 | 0.0428 | 0.0889 | 11.48 |
| 10 | 12 | 55.1569 | 55.2177 | 55.2646 | 0.0608 | 0.0469 | 0.1077 | 13.91 |
| 10 | 14 | 55.2345 | 55.2850 | 55.3250 | 0.0505 | 0.0400 | 0.0905 | 11.69 |
| 10 | 16 | 55.1633 | 55.2029 | 55.2401 | 0.0396 | 0.0372 | 0.0768 | 9.92 |
| 10 | 18 | 54.9972 | 55.0394 | | 0.0422 | | | 10.90 |
| 10 | 20 | 55.2262 | 55.2582 | 55.2890 | 0.0320 | 0.0308 | 0.0628 | 8.11 |

Data in Table 4 shows that coating weights for each side and per side are very similar for all samples and varied from 8.11-13.91 g/m².

The sprayed samples were cured at room temperature. Each sample was also tested for coating rub resistance after room temperature cure. The steel samples were also spray coated with 10% boric acid solution in methanol and increasing amounts of PVP (31%) solution in methanol from 10 to 20% and cured at room temperature. Data obtained by the testing showed the following:

1. At 10% PVP, there was a very slight rub off of the boric acid.

2. At greater than 10% PVP levels no rub off was noted.

3. Coating smoothness increased as PVP content increased. This was noted at PVP levels of equal to or greater than 14%.

4. All samples when heated to the steel processing temperature of 940° C. for 5 minutes in air followed by steel block quenched, resulted in good quality protective coatings with essentially no debonding from the steel surface.

This example clearly showed that when a boric acid solution containing a binder is applied to steel, it can protect the steel from oxidation in air, when heated to temperatures of 940° C. for 5 minutes. Furthermore, this example also provided the guidance in effects of the binder variations for a fixed amount of 10% of boric acid.

### Example 2. Effect of Boric Acid Concentration on the Quality of Steel Coated Surface with a Fixed Amount of PVP Binder

In this example, a 10% solution of boric acid in methanol was prepared. To this solution was added a 20% of 31% solution of PVP in methanol (or 6.2% of PVP). The solution containing 10% boric acid and 20% PVA was progressively changed to get the boric acid concentrations of 12, 16, and 20%, while PVA concentration was kept fixed at 20%. For each solution composition, steel samples of 2×3-in and of 0.071-in thickness were spray coated. The coating amount on each side and coating weight per side (g/m²) are summarized in Table 5. Table 5 includes data for coating details when solutions of 10, 12, 16 and 20% of boric acid with a 20% of PVP were sprayed on 2×3-in steel samples of 0.071-in thick

TABLE 5
Data for coating details where solutions of 10, 12, 16 and 20% of boric acid
with a 20% of PVP were sprayed on 2 × 3-in steel samples of 0.071-in thick

| | | | | | Coating | Coating | Coating | Coating |
|---|---|---|---|---|---|---|---|---|
| Boric | PVP | Sample | Sample | Sample | Weight | Weight | Weight | Weight |
| Acid | Solution | Weight | Weight | Weight | Side1 | Side2 | both Sides | per side |
| (%) | (31%) | (g) | (g) | (g) | (g) | (g) | (g) | (g/m\hat{ }2) |
| 10 | 20 | 55.1791 | 55.215 | 55.2425 | 0.0359 | 0.0275 | 0.0634 | 8.19 |
| 12 | 20 | 55.2333 | 55.2568 | 55.2772 | 0.0235 | 0.0204 | 0.0439 | 5.67 |
| 16 | 20 | 55.2478 | 55.2691 | 55.3009 | 0.0213 | 0.0318 | 0.0531 | 6.86 |
| 20 | 20 | 54.9856 | 55.0115 | 55.0332 | 0.0259 | 0.0217 | 0.0476 | 6.15 |

Data in Table 5 shows that coating weights for each side and per side are very similar for all samples and varied from 5.67-8.19 g/m². The steel samples were spray coated with solutions of 10, 12, 16, and 20% of boric acid with a 20% of PVP (31%) after being air cured at room temperature and heated to temperatures of 940° C. for 5 minutes in air. As the boric acid content is increased from 10 to 20%, with a fixed amount of PVP of 20%, the coating color after heating at temperature of 940° C. for 5 minutes in air, changes from blue to gray. The change in color is progressive and is blue up to 12% and gray at higher levels of boric acid up to 20%. The blue color is attributed to iron oxide rich coating and the gray color to boric oxide rich coating. This example clearly showed that a boric acid solution containing a binder when applied to steel can protect the steel from oxidation in air, when heated to temperatures of 940° C. for 5 minutes. Furthermore, this example also provided the guidance in effects of the boric acid content on the desired oxide on the surface (iron oxide/boric oxide).

### Example 3. Coating of Large Steel Panels with a Solution of 10% of Boric Acid and 10% PVP (31%) and Heating the Panels in a Continuous Nitrogen Atmosphere Furnace at 940° C. for 5 Minutes

In this example, 20 steel panels of 0.045-in thickness and of 192 in² surface area per side were spray coated with a 10% boric acid and a 10% PVA (31%) solution in methanol using an air spray gun. Each side of the coated sample was then cured in air. The amount of solution used for all of the panels was 300 ml of 15 ml per panel. Table 6 includes a summary of data related to coating the 10% boric acid and 10% PVA (31%) solution in methanol on 20 steel panels of 192 in² surface area. The details of the amounts of products used to make the solution and the coating weight per side are summarized in Table 6.

TABLE 6

| | Solution | | | | Total | Total | Total | Total |
|---|---|---|---|---|---|---|---|---|
| | used per | Solution | | | methanol | solid | solid | solid |
| Blank | Blank on | used per | Boric acid/ | PVP/ | content per | content per | content | content |
| Area | one side | in\hat{ }2 | 1000 ml | 1000 ml | 1000 ml | 1000 ml | per 1 ml | per side |
| (in\hat{ }2) | (ml) | (ml/in\hat{ }2) | (g) | (g) | (ml) | (g) | (g) | (g/m\hat{ }2) |
| 192 | 7.5 | 0.039063 | 100 | 31 | 1000 | 131 | 0.131 | 7.932 |

The steel panels of this example were coated with the 10% boric solution with 10% of PVP (31%) in methanol. The air cured coated samples were heated in a continuous nitrogen atmosphere furnace at 940° C. for 5 minutes. The steel panels coated with a 10% boric solution with 10% of PVP (31%) in methanol were heated in a continuous nitrogen atmosphere furnace at 940° C. for 5 minutes. Steel parts were hot stamped from the panels coated with a 10% boric solution with 10% of PVP (31%) in methanol and heated in a continuous nitrogen atmosphere furnace at 940° C. for 5 minutes. The test results show the 10% boric solution with 10% of PVP (31%) in methanol when applied to bare steel gives excellent protection against any oxidation when heated in a continuous nitrogen atmosphere furnace at 940° C. for 5 minutes. Furthermore, the iron borate coating that forms during the high temperature exposure stays intact during the hot stamping and under rapid quench conditions. This is highly desirable result in high volume production in hot stamping operations.

### Example 4. Coating of Large Steel Panels with a Solution of 16% of Boric Acid and 15% PVP (31%) and Heating the Panels in a Continuous Nitrogen Atmosphere Furnace at 940° C. for 5 Minutes

In this example, 22 steel panels of 0.045-in thickness and of 192 in² surface area per side were spray coated with a 16% boric acid and a 15% PVA (31%) solution in methanol using an air spray gun. Each side of the coated sample was then cured in air. The amount of solution used for all of the panels was 400 ml of 18.18 ml per panel. Table 7 includes a summary of data related to coating the 16% boric acid and 15% PVA (31%) solution in methanol on 22 steel panels of 192 in² surface area. The details of the amounts of products used to make the solution and the coating weight per side are summarized in Table 7.

TABLE 7

| | Solution | | | | Total | Total | Total | Total |
|---|---|---|---|---|---|---|---|---|
| | used per | | | | methanol | solid | solid | solid |
| Blank | Blank on | Solution | Boric acid/ | PVP/ | content per | content per | content | content |
| Area | one side | used per | 1000 ml | 1000 ml | 1000 ml | 1000 ml | per 1 ml | per side |
| (in\hat{ }2) | (ml) | in\hat{ }2 | (g) | (g) | (ml) | (g) | (g) | (g/m\hat{ }2) |
| 192 | 9.09 | 0.047344 | 160 | 46.5 | 1000 | 206.5 | 0.2065 | 15.154 |

The steel panels were coated with the 16% boric solution with 15% of PVP (31%) in methanol. The air cured coated samples were then heated in a continuous air atmosphere furnace at 940° C. for 5 minutes and then formed. Steel parts were hot stamped from the panels coated with the 16% boric solution with 15% of PVP (31%) in methanol and heated in a continuous air atmosphere furnace at 940° C. for 5 minutes. The test results show the 16% boric solution with 15% of PVP (31%) in methanol when applied to bare steel gives excellent protection against any oxidation when heated in a continuous air atmosphere furnace at 940° C. for 5 minutes. Furthermore, the iron borate coating that forms during the high temperature exposure stays intact during the hot stamping and under rapid quench conditions. This is highly desirable result in high volume production in hot stamping operations.

### Example 5. E-Cote Response of Large Steel Panels Coated with a Solution of 10% of Boric Acid and 4% PVP (31%) and Heating the Panels in a Continuous Nitrogen Atmosphere Furnace at 940° C. for 5 Minutes

In this example, large steel panels were spray coated with a solution of 10% of boric acid and 4% PVP (31%), and the panels were heated in a continuous nitrogen atmosphere furnace at 940° C. for 5 minutes. The boric acid coated panels after heating and hot stamping were of uniform surface finish and of the same color. Two of the parts were E-coated using the standard E-coat process and found to have no issues.

The successful E-coating of the iron borate coated surface suggests that these coating are very thin and also have sufficient conductivity for the E-coat process to take place, as it does on parts that are not treated with the boric acid solutions. This also implies that the current post processing treatments that are now used on hot stamped parts will be applicable to the parts coated with the boric acid solutions.

### Example 6. Testing the Coating for any Decarburization in the Steel Substrate

In this example, a 2×3-in steel sample of 0.045-in thickness was spray coated with a solution of 10% of boric acid and 10% PVP (31%) and cured at 300° F. for 1 minute on each side. The cured sample was heated in a box furnace in air atmosphere at 940° C. for 5 minutes. The coating was of lighter blue color and came off the sample from both sides leaving clean steel surfaces. The samples had a superfine grain size and about 4-micron decarburization. Micrographs showed the grain refinement of steel and a very minor level of about 4 microns of decarburization layer. The fine structure could be a result of a small amount of dissolution of boron from the coating in to steel.

Four example parts were then evaluated purposes of comparison. The first part was formed without a coating and heated in a furnace with an air atmosphere. The second part was formed with a solution of 10% of boric acid and 10% PVP (31%) coating and heated in a furnace with a nitrogen (N₂) atmosphere. The third part was formed with a solution of 16% of boric acid and 15% PVP (31%) coating and heated in a furnace with an air atmosphere. The fourth part was formed with a 16% of boric acid and 4% EC coating and heated in a furnace with an air atmosphere.

Four more example parts were then evaluated for purposes for comparison. The first part was formed without a coating and heated in a furnace with an air atmosphere. The second part was formed with a solution of 10% of boric acid and 10% PVP (31%) coating and heated in a furnace with a nitrogen (N₂) atmosphere. The third part was formed with a solution of 16% of boric acid and 15% PVP (31%) coating and heated in a furnace with an air atmosphere. The fourth part was formed with a 16% of boric acid and 4% EC coating and heated in a furnace with an air atmosphere.

### Example 7. Coating Trial and Test

A trial to find the best solution and path to reduce oxidization by applying a boric acid flux on both sides of steel samples was conducted. The step of applying the flux included brushing or spaying a liberal amount of the flux over the entire steel surfaces, or dipping the entire steel sample in the flux. The coated samples were lit with a torch to create a green flame and burn off the alcohol. The coated samples were also hot stamped in a hot stamping line to find the best hot stamping solution. Different flux or coating compositions were applied to the samples and tested to determine the preferred composition.

It was found that boric acid, PVP K-30, and methanol make an excellent flux for preventing oxidization and decarburization. Boric acid is non-toxic to people, making it a great alternative to fluoride based fluxes. Thus oxide scale and decarburization is reduced by the surface treatment process described above.

The following documents and sources are cited as additional information referenced during the coating development and trial: U.S. Pat. No. 1,817,888 (Alborizing, 1927), US Patent Application Publication No. 2012/0183708 A1, a product data sheet for PVP K-30 polymer provided by Ashland and available at http://www.brenntag.com/media/documents/bsi/product_data_sheets/material_science/ashland_polymers/pvp_k-30_polymer_pds.pdf, a PVP Brochure provided by Ashland and available at http://ragitesting.com/resourcePortfolio/wp-content/uploads/2014/09/ASH-PC8091_PVP_Brochure_VF.pdf, information available at http://etsymetal.blogspot.com/2009/05/intro-to-using-boric-acid-flux.html, and information available at https://www.target.com/p/mule-team-borax-all-natural-detergent-booster-multi-purpose-household-cleaner-65-oz/-/A-13315486.

### Example 8. Coating Trial and Test

Additional tests were conducted to determine protective surface treatments for hot stamped steel parts, such as 0.22C-1.5Mn—B steel. The first step of the hot stamping process was to heat the sheet metal to finish a phase transformation from a ferrite phase to an austenite phase. Based on a phase diagram, the austenite temperature of 0.22C-1.5Mn—B steel is 850° C. To speed up the phase austenization transformation, hot stampers heat the sheet metal to 930-970° C. During and under austenization conditions, oxide scale formation and decarburization occurs immediately when the steel is in contact with air in this temperature range. Oxide scale formation and decarburization typically occurs during the process.

The additional tests included applying a solution of 10% boric acid, 4% PVP polymer, and methanol to the steel samples, and the samples were processed with a nitrogen protect gas environment. Some of the samples were also e-coated without sandblasting.

Other samples were processed in a nitrogen protect gas environment by applying 10% boric acid, 10% PVP polymer, and methanol. Some samples were processed without a nitrogen protect gas environment by applying 16% boric acid, 15% PVP polymer, and methanol. Yet other samples were processed with a nitrogen protective gas environment by applying 16% boric acid, 15% ethylcellulose, polymer, and methanol.

Based on the test results, it was concluded that processing in the nitrogen protective environment with 10% boric acid, 10% PVP, and methanol, and processing in the air environment with 16% boric acid, 15% PVP, and methanol results in no scale, no oxidization, and no decarburization on the metal surface. Processing in the air environment with 16% boric acid, 15% ethylcellulose, polymer, and methanol did not achieve the same results.

It was also concluded that steel can be protected from oxidization or decarburization by using boric acid due to a Fe₃BO₃ glass layer formed during heat up in the hot stamping process, and the glass has good formability at the hot stamping temperature. This is the reason for no cracks on the surface. The glass layer also serves as a corrosion protection layer. Thus, the hot stamped parts with the boric acid treatment are better protected than those with no boric acid treatment.

Based on this test, it was also concluded that several additional approaches are possible. One additional approach is to use 16% boric acid, 15% PVP, rosin, and methanol solution to take care of a water issue. A second approach is to use 16% boric acid, 15% PVP, 3% ethylcellulose, and methanol to take care of the water issue. A third additional approach is to develop another method to coat a steel coil by a spray or roller.

### Example 9. Deposition of Glass Forming Treatment Blend on Steel Sheet and its Thickness

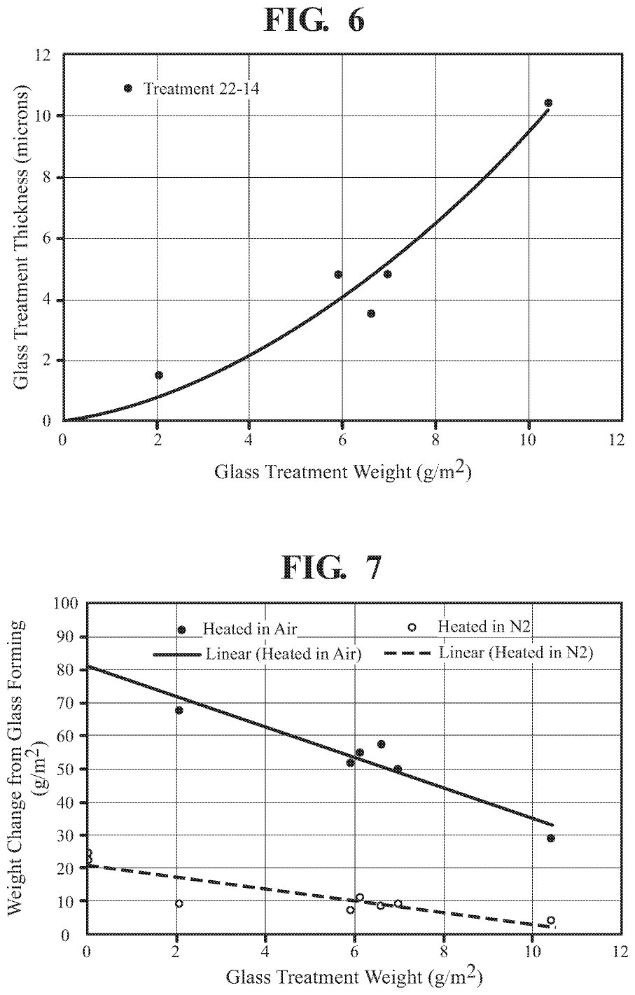

In this example, a blend consisting of iron borate forming glass was used and the treatment weight was measured in grams/m\hat{ }2 and the thickness was measured in microns using a Fisher Scope. The blend consisted of 22% by weight of the borate glass forming compound, a 14% by weight of an acrylic binder and 64% by weight of the solvent and the solvent used was commercial grade of ethanol. The treatment was applied using a roller system at a speed of 365 ft./min. Prior to treatment application, the steel was cleaned using a 1-2% by weight of alkali solution. The primary constituent of the alkali was potassium hydroxide. The steel with applied treatment was run through an oven at 300° F. at 365 ft./min. The treatment thickness and weight are plotted in FIG. 6, prior to heating to temperature to form the glass. Note that treatment thicknesses are in the range of 2-10 microns and as will be described in other examples, a preferred treatment thickness is 4-6 microns.

### Example 10. Deposition of Glass Forming Treatment Blend on Steel Sheet and its Response to Heating in Air and Nitrogen Atmosphere for 5 Minutes at 940° C.

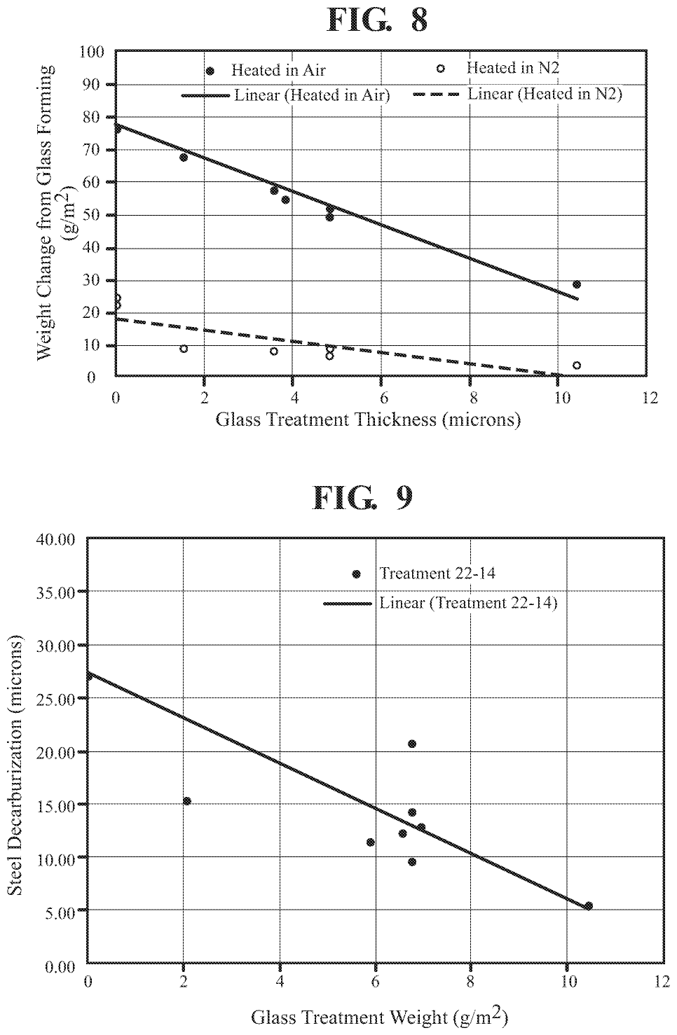

In this example, the steel samples of 2×3-in size were taken from the steel coated with the details given in example 9. Samples of the steel without the glass treatment were also included in the testing. Samples were heated in a box furnace to a temperature of 940° C. for 5 minutes. One set of samples were heated with air in the box furnace and the other set where the air in the box was displaced by flowing Nitrogen gas. Samples were weighed before and after heating. After heating the samples were placed on 1-in thick steel blocks to simulate the hot die quenching process. The weight change data from glass forming per unit surface area, are plotted as a function of the glass treatment weight in g/m\hat{ }2 in FIG. 7 and as a function of treatment thickness in microns in FIG. 8. Data in these figures show, the for the uncoated steel with no glass forming, there is a significant weight gain, which comes from oxidation of steel. The oxide scale can be thick to spall off during the steel block quench. The oxide formed for uncoated samples is rapid growing, however, samples with the glass forming treatment, convert the iron oxide for the uncoated steel to a borate glass which is very slow growing at 940° C. Data in FIG. 7 shows a linear decrease in the weight gain as the iron oxide is converted to more complete iron borate glass with increasing amount of the applied treatment. A 50% reduction in weight gain, when heated in air is obtained when treatment weight is 6-7 g/m\hat{ }2. The FIG. 8 shows that the 50% reduction in weight gain correspond to a glass treatment thickness of 6-7 microns. FIG. 7 shows that when atmosphere is N2, the reduction in air in the box furnace reduces the iron oxide formation of the uncoated sample by 75%. However, even in nitrogen atmosphere, the glass forming treatment forms the iron borate glass and the weight gain is reduced by 50% at treatment weight of 6 g/m\hat{ }2, FIG. 7 or at a treatment thickness of 4-5 microns, FIG. 8.

Data in FIGS. 7 and 8 clearly show the benefits of glass forming treatment in keeping the steel components, formed at high temperatures of 940° C., clean in all aspects and providing the benefits listed in a previous section.

### Example 11. Deposition of Glass Forming Treatment Blend on Steel Sheet and its Response to Reducing Decarburization of Steel after Heating in Nitrogen Atmosphere for 5 Minutes at 940° C.

In this example, the steel blanks of a complex shape were stamped from the steel coated with the details given in example 9. Blanks of same shape of the steel without the glass treatment were also included in the testing. Samples were heated in a continuous furnace, with nitrogen atmosphere, to a temperature of 940° C. for 5 minutes. Heated blanks were die formed and quenched. The formed parts were metallographically examined to determine depth of steel at surface that showed decarburization. Data are plotted as a function of the glass treatment weight in g/m\hat{ }2 in FIG. 9. Data in this figure shows, that for the uncoated steel with no glass forming, there is a significant decarburization depth. This happens, because, the iron oxide forming on the surface of the uncoated steel, removes the carbon from the steel. However, samples with the glass forming treatment, convert the iron oxide for the uncoated steel to a borate glass which reduces the removal of carbon from steel. Data in FIG. 9 shows a linear decrease in the decarburization depth as the iron oxide is converted to more complete iron borate glass with increasing amount of the applied treatment. A 50% reduction in decarburization depth is reached at a treatment weight of 6-7 g/m\hat{ }2, which is the same range seen in FIG. 7, for heating the samples in air or nitrogen atmosphere.

### Example 12. Deposition of Glass Forming Treatment Blend Variant and Application Methods on Steel Sheet and its Response to Heating in Nitrogen Atmosphere for 5 Minutes at 940° C.

In this example, the glass forming treatment blend was modified to contain 10% by weight of the borate glass forming additive, the acrylic binder was in the range of 2-4% by weight and the solvent was 86-88% by weight. The solvent used was commercial grade of ethanol. The steel samples of 2×3-in size were used for this example. Prior to treatment application, the steel samples were cleaned using a 1-2% by weight of alkali solution. The primary constituent of the alkali was potassium hydroxide. The glass treatment was applied by two methods. In one set the blend was applied by spraying and in the second set, the blend was rolled on using a rubber paint roller. The roller application produced a treatment weight of 2-3 g/m\hat{ }2. The spray treatment resulted in coating weights in the range of 9-12 g/m\hat{ }2. All samples after roll or spray application were air dry and heated to 300° F. for 1 minute.

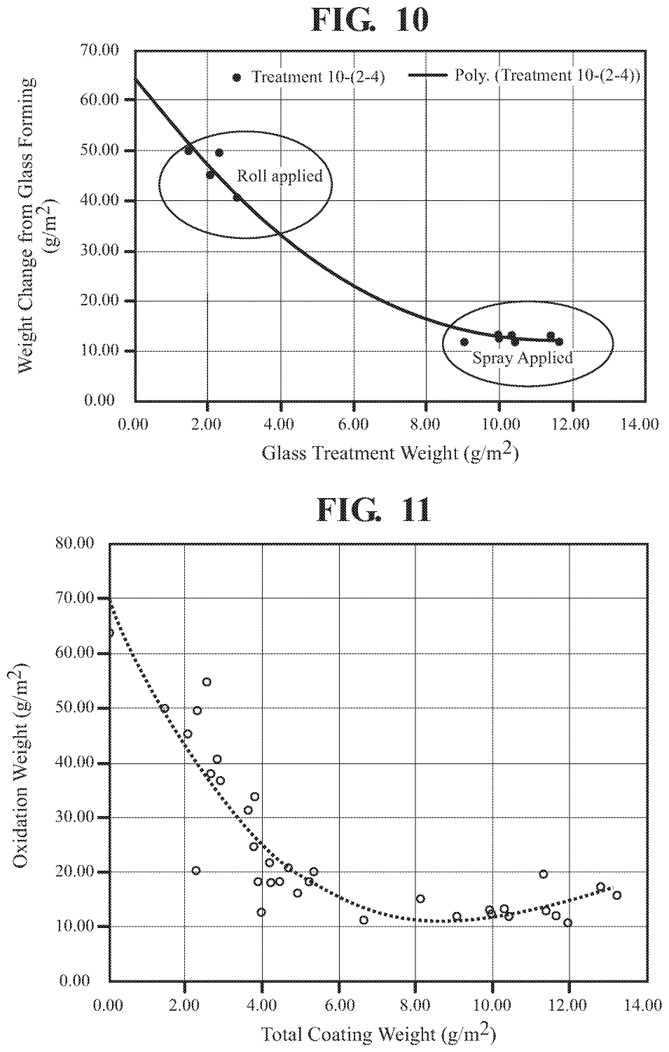

Samples of the steel without the glass treatment were also included in the testing. Samples were heated in a box furnace to a temperature of 940° C. for 5 minutes in nitrogen atmosphere. Samples were weighed before and after heating. After heating the samples were placed on 1-in thick steel blocks to simulate the hot die quenching process. The weight change data from glass forming per unit surface area, are plotted as a function of the glass treatment weight in g/m\hat{ }2 in FIG. 10. Data in these FIG. 10 shows, the trends similar to those seen when the treatment was 22-14 in example 9. There is a clear reduction in weight change as the treatment weight increases. Furthermore, weight change from heating at 940° C. can be as large as 60-70% for a treatment weight of 7 g/m\hat{ }2. This is an important result in that it shows that the glass forming treatment composition can have a broad range of borate glass forming additive, 10-22%. It also shows that the acrylic binder can be as low as 2-4%. The most important observation is that the treatment can be applied by spray or roll method. The roll application is more feasible for high production rates and the spray application for applications in the field to complex shapes that are not amenable to high production processing.

### Example 13. Deposition of Glass Forming Treatment Blend Variant Over a Board Range its Response to Heating in Nitrogen Atmosphere for 5 Minutes at 940° C.

In this example, the glass forming treatment blend was modified to contain 10-22% by weight of the borate glass forming additive, the acrylic binder was in the range of 2-6% by weight and the solvent was 72-88% by weight. The solvent used was commercial grade of ethanol. The steel samples of 2×3-in size were used for this example. Prior to treatment application, the steel samples were cleaned using a 1-2% by weight of alkali solution. The primary constituent of the alkali was potassium hydroxide. The glass treatment was applied by three methods. In one set the blend was applied by spraying, in the second set, the blend was rolled on using a rubber paint roller and in the third set the blend was applied by painting with a brush. The roller application produced a treatment weight of 2-4 g/m\hat{ }2. The spray treatment resulted in coating weights in the range of 9-12 g/m\hat{ }2 and brushing gave the treatment weights in between. All samples after roll or spray application were air dry and heated to 300° F. for 1 minute.

Samples of the steel without the glass treatment were also included in the testing. Samples were heated in a box furnace to a temperature of 940° C. for 5 minutes in nitrogen atmosphere. Samples were weighed before and after heating. After heating the samples were placed on 1-in thick steel blocks to simulate the hot die quenching process. The weight change data from glass forming per unit surface area, are plotted as a function of the glass treatment weight in g/m\hat{ }2 in FIG. 11. Data in this shows, a significant reduction in weight gain from oxidation of an uncoated sample with increase in treatment weight. With large number of samples tested, it is clear, one gets a large reduction in oxidation weight for treatment weight of up to 7 g/m\hat{ }2. Beyond this improvement is minimal. Thus, it is recommending that treatment weight of 7 g/m\hat{ }2 is more desirable for optimum performance.

In summary, steel prepared by applying a mixture to the steel, wherein the mixture includes a flux agent, at least one binder, and at least one solvent, and wherein the flux agent includes at least one of boric acid, sodium borate, sodium tetraborate, disodium tetraborate, calcium fluoride, sodium carbonate, potash, charcoal, coke, lime, lead sulfide, ammonium chloride, limestone, metal halide, zinc chloride, hydrochloric acid, phosphoric acid, hydrobromic acid, salt of a mineral acid, mineral acid with amine, carboxylic acid, fatty acid, amino acid, organohalide, boron, and silicon, and heating the mixture on the body portion to a temperature in the range of 200 to 1200° C., has applications in many sectors. The coated steel also provides several advantages, including over 50% reduction in oxidation weight gain in air and inert furnace environments at temperatures of 600-1200° C. Applications of the coated steel include hot forming of automotive and truck parts with reduced oxidation and decarburization. For example, the method can include hot forming after heating the mixture on the body portion, to a temperature of 600-1200° C., and to a temperature of preferably 940° C. Applications of the coated steel also include a broad range of ambient temperature applications, where corrosion is critical.

The process of applying a mixture to a body portion including metal or alloy, wherein the mixture includes a flux agent, at least one binder, and at least one solvent, and wherein the flux agent includes at least one of boric acid, sodium borate, sodium tetraborate, disodium tetraborate, boron oxide, calcium fluoride, sodium carbonate, potash, charcoal, coke, lime, lead sulfide, ammonium chloride, limestone, metal halide, zinc chloride, hydrochloric acid, phosphoric acid, hydrobromic acid, salt of a mineral acid, mineral acid with amine, carboxylic acid, fatty acid, amino acid, organohalide, boron, and silicon, and heating the mixture on the body portion to a temperature in the range of 200 to 1200° C., has applications in many sectors. The process can be used for heat treatment of parts to minimize decarburization. One such application is heat-treating of gears. In this case, the gears will be coated by dipping or spraying. For example, the component can be a gear for a broad range of gear applications. The protective surface treatment applied to the component, in this case the gear, can prevent decarburization during heat treating.

The process described herein is a protective surface treatment process for the manufacturing environment of metal alloy components and thereafter providing the same or better mechanical properties, the same or better forming response, the same or better weldability, oxidation and corrosion resistance, E-coating compatibility, and lower cost. It is a unique surface treatment process that provides the following key benefits: replaces oil treatment to prevent rusting of steel; forms a glassy phases when heated to 200-1200° C. or 300-1200° C.; the glassy phases reduce the steel substrate oxidation during high temperature heating in air and inert atmospheres; the glassy phases allow hot die forming of complex steel shapes without spallation; the glassy phases are sufficiently thin to not affect the part quench rates and thus full benefits of properties in steel parts are achieved; the glassy phases are lubricious at hot forming temperatures to reduce the forming loads; the lubricity of the glassy phases reduces the die wear; by preventing the oxidations, the glassy phases also minimize any decarburization of steel; the glassy phases have no effect on the welding of the components; the glassy phases on the formed parts provide corrosion protection at ambient conditions and thus not requiring, any post part shot blasting and oiling; since the glassy phases result in the quenched microstructure, no change in the mechanical properties are noted; the formed parts with the glassy phase require minimum cleaning for post e-coat; the treatment results in large cost savings from all of the benefits listed above.

Obviously, many modifications and variations of the present invention are possible in light of the above teachings and may be practiced otherwise than as specifically described while within the scope of the following claims.

1. A method of manufacturing a component, comprising the steps of:
applying a mixture to a body portion, the body portion including a metal or metal alloy;
the mixture including a flux agent, at least one binder, and at least one solvent;
the flux agent including at least one of boric acid; sodium borate; sodium tetraborate; disodium tetraborate; boron oxide; calcium fluoride; sodium carbonate; potash; charcoal; coke; lime; lead sulfide; ammonium chloride; limestone; metal halide; zinc chloride; hydrochloric acid; phosphoric acid; hydrobromic acid; salt of a mineral acid; mineral acid with amine; carboxylic acid; fatty acid; amino acid; organohalide; boron; silicon; a mixture containing 20 wt. % MnO, 15 wt. % CaF₂, and SiO₂ to CaO ratios varying from 5.50 to 1.16; tin(II) chloride; a fluoride; and precursors to silicate and borosilicate glasses; and
heating the mixture on the body portion to a temperature in the range of 200 to 1200° C.

2. A method according to claim 1, wherein the body portion is formed of steel.

3. A method according to claim 1, wherein the flux agent includes at least one of boric acid, sodium borate, borax, sodium tetraborate, and disodium tetraborate; and the heating step includes forming iron borate.

4. A method according to claim 1, wherein the flux agent is present in an amount of 1 to 30 wt. %, based on the total weight of the mixture.

5. A method according to claim 1, wherein the binder includes at least one of polyvinylpyrrolidone (PVP), polyvinylpyrrolidone/vinyl acetate (PVP/VA), hydroxypropyl cellulose (HPC), ethyl cellulose, and acrylic.

6. A method according to claim 1, wherein the binder is present in an amount of 1 to 30 wt. %, based on the total weight of the mixture.

7. A method according to claim 1, wherein the solvent includes at least one of methanol, acetone, MEK, ethanol, and denatured alcohol.

8. A method according to claim 1, wherein the mixture further includes at least one additive, and the at least one additive includes at least one of a solvent soluble element or compound of Zn, Cr, Mn, Si, B, Al, Cu, Co, Ni, Zr, Hf, Ti, Ta, Mo, W, Ag, Au, Fe, TiO₂, SiO₂, Al₂O₃, and/or SiO₂—Al₂O₃; nano sized particles of C, B, Si, Al, Zn; and nano sized oxides of Al, Si, Ti, Cr, and Mo.

9. A method according to claim 8, wherein the at least one additive is present in an amount of 0.1 to 1 wt. %, based on the total weight of the mixture.

10. A method according to claim 1, wherein the flux agent is boric acid, the binder is PVP, and the solvent is methanol.

11. A method according to claim 1, wherein the flux agent is boric acid, the binder is acrylic, and the solvent is ethanol.

12. A method according to claim 1, wherein the step of applying the mixture includes at least one of spraying, painting, and rolling the mixture on the body portion.

13. A method according to claim 12, wherein the body portion is provided as a coil formed of steel, and the step of applying the mixture includes rolling.

14. A method according to claim 1 including curing the binder by heating the mixture at a temperature in the range of 100 to 300° F.

15. A method according to claim 14, wherein the furnace includes an atmosphere of air, nitrogen, or nitrogen and natural gas.

16. A method according to claim 1 including hot forming the body portion after heating the mixture on the body portion to 600 to 1200° C.

17. A method according to claim 1 including hot forming the body portion after heating the mixture on the body portion to a temperature of 940° C.

18. A component, comprising:
a body portion including a metal or metal alloy,
a coating disposed on said body portion, and said coating including iron borate.

19. A component according to claim 18, wherein said coating includes at least one of Zn, Cr, Mn, Si, B, Al, Cu, Co, Ni, Zr, Hf, Ti, Ta, Mo, W, Ag, Au, Fe, TiO₂, SiO₂, Al₂O₃, and/or SiO₂—Al₂O₃; nano sized particles of C, B, Si, Al, Zn; and nano sized oxides of Al, Si, Ti, Cr, and Mo.

20. A component according to claim 18, wherein said body portion is formed of steel.

21. A component according to claim 18, wherein said component is a part for an automotive or truck.

22. A component according to claim 18, wherein said component is a gear, and said coating prevents decarburization during heat treating.

23. (canceled)

24. A component, comprising:
a body portion including a metal or metal alloy,
a coating disposed on said body portion, and said coating including metal oxide, silicate, borosilicate, and/or alkali metal silicate.
